(19) United States
(12) Patent Application Publication
(10) Pub. No.: US 2024/0322871 A1
(43) Pub. Date: Sep. 26, 2024

(54) HIGH RANK MULTIPLE INPUT MULTIPLE OUTPUT FOR MULTI-BAND ANTENNA MODULE WIRELESS COMMUNICATION DEVICES

(71) Applicant: QUALCOMM Incorporated, San Diego, CA (US)

(72) Inventors: Vasanthan RAGHAVAN, West Windsor Township, NJ (US); Junyi LI, Fairless Hills, PA (US); Juergen CEZANNE, Ocean Township, NJ (US)

(21) Appl. No.: 18/186,546

(22) Filed: Mar. 20, 2023

(51) Int. Cl. H04B 7/0456; H04B 1/00

(52) U.S. Cl. CPC H04B 7/0486; H04B 1/0064; H04B 7/0473

(57) ABSTRACT

Various aspects of the present disclosure generally relate to wireless communication. In some aspects, a user equipment (UE) may transmit, to a network node, an indication of a capability to support high rank multiple input multiple output (MIMO) communication on two or more frequency bands that have a common intermediate frequency. The capability to support the high rank MIMO communication includes a capability to support MIMO communication in approximately a same direction and on greater than two layers. The UE may perform high rank MIMO communication with the network node on the two or more frequency bands in approximately the same direction. Numerous other aspects are described.

### FIELD OF THE DISCLOSURE

Aspects of the present disclosure generally relate to wireless communication and to techniques and apparatuses for high rank multiple input multiple output for multi-band antenna module wireless communication devices.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, or the like). Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3GPP).

A wireless network may include one or more network nodes that support communication for wireless communication devices, such as a user equipment (UE) or multiple UEs. A UE may communicate with a network node via downlink communications and uplink communications. “Downlink” (or “DL”) refers to a communication link from the network node to the UE, and “uplink” (or “UL”) refers to a communication link from the UE to the network node. Some wireless networks may support device-to-device communication, such as via a local link (e.g., a sidelink (SL), a wireless local area network (WLAN) link, and/or a wireless personal area network (WPAN) link, among other examples).

The above multiple access technologies have been adopted in various telecommunication standards to provide a common protocol that enables different UEs to communicate on a municipal, national, regional, and/or global level. New Radio (NR), which may be referred to as 5G, is a set of enhancements to the LTE mobile standard promulgated by the 3GPP. NR is designed to better support mobile broadband internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink, using CP-OFDM and/or single-carrier frequency division multiplexing (SC-FDM) (also known as discrete Fourier transform spread OFDM (DFT-s-OFDM)) on the uplink, as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

Some aspects described herein relate to a method of wireless communication performed by a user equipment (UE). The method may include transmitting, via a transceiver and to a network node, an indication of a capability to support high rank multiple input multiple output (MIMO) communication on two or more frequency bands that have a common intermediate frequency, where the capability to support the high rank MIMO communications includes a capability to support MIMO communication in approximately a same direction and on greater than two layers. The method may include performing, via the transceiver, the high rank MIMO communication with the network node on the two or more frequency bands in approximately the same direction.

Some aspects described herein relate to a method of wireless communication performed by a network node. The method may include receiving, from a UE, an indication of a capability of the UE to support high rank MIMO communication on two or more frequency bands that have a common intermediate frequency, where the capability to support the high rank MIMO communication includes a capability to support MIMO communication in approximately a same direction and on greater than two layers. The method may include performing the high rank MIMO communication with the UE on the two or more frequency bands in approximately the same direction.

Some aspects described herein relate to a UE for wireless communication. The UE may include a memory, one or more processors coupled to the memory, and a transceiver. The one or more processors may be configured to transmit, via the transceiver and to a network node, an indication of a capability to support high rank MIMO communication on two or more frequency bands that have a common intermediate frequency, where the capability to support the high rank MIMO communications includes a capability to support MIMO communication in approximately a same direction and on greater than two layers. The one or more processors may be configured to perform, via the transceiver, the high rank MIMO communication with the network node on the two or more frequency bands in approximately the same direction.

Some aspects described herein relate to a network node for wireless communication. The network node may include a memory and one or more processors coupled to the memory. The one or more processors may be configured to receive, from a UE, an indication of a capability of the UE to support high rank MIMO communication on two or more frequency bands that have a common intermediate frequency, where the capability to support the high rank MIMO communication includes a capability to support MIMO communication in approximately a same direction and on greater than two layers. The one or more processors may be configured to perform the high rank MIMO communication with the UE on the two or more frequency bands in approximately the same direction.

Some aspects described herein relate to a non-transitory computer-readable medium that stores a set of instructions for wireless communication by a UE. The set of instructions, when executed by one or more processors of the UE, may cause the UE to transmit, via a transceiver and to a network node, an indication of a capability to support high rank MIMO communication on two or more frequency bands that have a common intermediate frequency, where the capability to support the high rank MIMO communications includes a capability to support MIMO communication in approximately a same direction and on greater than two layers. The set of instructions, when executed by one or more processors of the UE, may cause the UE to perform, via the transceiver, the high rank MIMO communication with the network node on the two or more frequency bands in approximately the same direction.

Some aspects described herein relate to a non-transitory computer-readable medium that stores a set of instructions for wireless communication by a network node. The set of instructions, when executed by one or more processors of the network node, may cause the network node to receive, from a UE, an indication of a capability of the UE to support high rank MIMO communication on two or more frequency bands that have a common intermediate frequency, where the capability to support the high rank MIMO communication includes a capability to support MIMO communication in approximately a same direction and on greater than two layers. The set of instructions, when executed by one or more processors of the network node, may cause the network node to perform the high rank MIMO communication with the UE on the two or more frequency bands in approximately the same direction.

Some aspects described herein relate to an apparatus for wireless communication. The apparatus may include means for transmitting, via the transceiver and to a network node, an indication of a capability to support high rank MIMO communication on two or more frequency bands that have a common intermediate frequency, where the capability to support the high rank MIMO communications includes a capability to support MIMO communication in approximately a same direction and on greater than two layers. The apparatus may include means for performing, via the transceiver, the high rank MIMO communication with the network node on the two or more frequency bands in approximately the same direction.

Some aspects described herein relate to an apparatus for wireless communication. The apparatus may include means for receiving, from a UE, an indication of a capability of the UE to support high rank MIMO communication on two or more frequency bands that have a common intermediate frequency, where the capability to support the high rank MIMO communication includes a capability to support MIMO communication in approximately a same direction and on greater than two layers. The apparatus may include means for performing the high rank MIMO communication with the UE on the two or more frequency bands in approximately the same direction.

Aspects generally include a method, apparatus, system, computer program product, non-transitory computer-readable medium, user equipment, base station, network entity, network node, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages, will be better understood from the following description when considered in connection with the accompanying figures. Each of the figures is provided for the purposes of illustration and description, and not as a definition of the limits of the claims.

While aspects are described in the present disclosure by illustration to some examples, those skilled in the art will understand that such aspects may be implemented in many different arrangements and scenarios. Techniques described herein may be implemented using different platform types, devices, systems, shapes, sizes, and/or packaging arrangements. For example, some aspects may be implemented via integrated chip embodiments or other non-module-component based devices (e.g., end-user devices, vehicles, communication devices, computing devices, industrial equipment, retail/purchasing devices, medical devices, and/or artificial intelligence devices). Aspects may be implemented in chip-level components, modular components, non-modular components, non-chip-level components, device-level components, and/or system-level components. Devices incorporating described aspects and features may include additional components and features for implementation and practice of claimed and described aspects. For example, transmission and reception of wireless signals may include one or more components for analog and digital purposes (e.g., hardware components including antennas, radio frequency (RF) chains, power amplifiers, modulators, buffers, processors, interleavers, adders, and/or summers). It is intended that aspects described herein may be practiced in a wide variety of devices, components, systems, distributed arrangements, and/or end-user devices of varying size, shape, and constitution.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with the present disclosure.

FIG. 2 is a diagram illustrating an example of a network node in communication with a user equipment (UE) in a wireless network, in accordance with the present disclosure.

FIG. 3 is a diagram illustrating an example disaggregated base station architecture, in accordance with the present disclosure.

FIGS. 4A-4C are diagrams of examples of high rank MIMO communication, in accordance with the present disclosure.

FIGS. 5A-5C are diagrams of examples of antenna modules for high rank MIMO communication, in accordance with the present disclosure.

FIGS. 6A and 6B are diagrams of an example of capability signaling for supporting high rank MIMO communication, in accordance with the present disclosure.

FIG. 7 is a diagram illustrating an example process performed, for example, by a UE, in accordance with the present disclosure.

FIG. 8 is a diagram illustrating an example process performed, for example, by a network node, in accordance with the present disclosure.

FIG. 9 is a diagram of an example apparatus for wireless communication, in accordance with the present disclosure.

FIG. 10 is a diagram of an example apparatus for wireless communication, in accordance with the present disclosure.

### DETAILED DESCRIPTION

In a wireless network, a network node and a user equipment (UE) may communicate via one or more beams. “Beam” may refer to a wireless communication signal that is beamformed and transmitted in a particular/set of spatial direction(s), as opposed to being transmitted omnidirectionally.

Millimeter wave (mmWave) beamforming may cover a set of frequencies in a frequency band such as FR2. Examples include operating bands n257, n258, n259, n261, and/or n260, among other examples. As the frequency bands that are used in a wireless network evolve, beamforming support is needed for additional frequencies such as n262 and n263, among other examples. However, these additional frequencies may be significantly different from currently-supported frequencies, which may result in the addition of additional antenna modules to a UE for supporting the additional frequencies.

In some aspects described herein, a UE may include one or more multiple-band (multi-band) antenna modules that cover a broad range of frequencies. “Multi-band antenna module” may refer to an antenna module that includes a first subset of antennas (or antenna elements) that are configured to support wireless communication on a first frequency band (e.g., an FR2 frequency band), and a second subset of antennas (or antenna elements) that are configured to support wireless communication on a second frequency band (e.g., an FR3 frequency band or a FR4 frequency band).

The inclusion of multi-band antenna modules in the UE provides the UE with capability to support high rank multiple input multiple output (MIMO) communication on two or more frequency bands. “High rank MIMO communication” (also referred to as higher rank MIMO communication) refers to wireless communication using greater than two polarization layers (e.g., 3 layers, 4 layers, or a greater quantity of layers) across two or more frequency bands. “Layer” may refer to a spatial or polarization wireless communication layer that is transmitted on (and/or received on) one or more beams.

The two or more frequency bands may have (or may share) a common intermediate frequency. “Intermediate frequency” may refer to a frequency between a radio frequency (RF) and a baseband frequency of the UE. Instead of converting signals directly between the RF frequency and the baseband frequency, the UE may convert (e.g., downconvert) an RF frequency to the intermediate frequency, and then convert (e.g., downconvert) from the intermediate frequency to the baseband frequency using a superheterodyne architecture. The UE may perform these operations in reverse order to convert (e.g., upconvert) from the baseband frequency to the RF frequency using the intermediate frequency. This enables the UE to convert communications via the two or more frequency bands between RF signals (e.g., analog signals that are transmitted and/or received via the two or more frequency bands) and baseband signals (e.g., signals that are processed by a modem or baseband processor of the UE) using the same (or common) intermediate frequency (as opposed to different intermediate frequencies for each of the two or more frequency bands).

To support the configuration and/or scheduling of high rank MIMO communication for the UE, the UE may provide signaling to a network node, where the signaling may indicate a capability of the UE to support high rank MIMO communication (e.g., on two or more frequency bands that have a common intermediate frequency). The signaling from the UE enables the network node to be made aware of the capability of the UE to support high rank MIMO communication, which enables the network node to configure and/or schedule high rank MIMO communication for the UE.

In some cases, lower rank transmissions (e.g., rank 1 transmissions in non-polarization-based transmissions on one layer, rank 2 transmissions in polarization-based transmissions on two layers) may be performed in a same (single) direction. However, as described herein, the UE and the network node may be capable of performing high rank MIMO communication on two or more frequency bands (e.g., that have a common intermediate frequency) in approximately a same direction. In these aspects, the signaling provided by the UE to the network node to indicate the capability of the UE to support high rank MIMO communication enables the UE and the network node to perform high rank MIMO communication in a certain chosen direction.

In some cases, high rank transmissions may be indicated by a higher value for a rank indicator (RI), where the RI is typically matched to an appropriate precoder matrix from a codebook for codebook-based beamforming (or an appropriate precoder matrix is derived for non-codebook-based beamforming). However, the RI is typically a measure of digital/baseband precoding rank. As described herein, the signaling provided by the UE to the network node to indicate the capability of the UE to support high rank MIMO communication may enable the UE to indicate one or more hybrid beamforming sets of beam weights to be supported for high rank MIMO communication. Thus, in aspects described herein, the signaling from the UE enables the use of RF/analog precoding (e.g., phase-shifting and/or automatic gain control (AGC) combining of antenna elements over the air) for high rank MIMO communication, as opposed to (and/or in addition to) digital precoding.

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. One skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, or the like (collectively referred to as “elements”). These elements may be implemented using hardware, software, or combinations thereof. Whether such elements are implemented as hardware or software depends upon the particular application and design constraints imposed on the overall system.

While aspects may be described herein using terminology commonly associated with a 5G or New Radio (NR) radio access technology (RAT), aspects of the present disclosure can be applied to other RATs, such as a 3G RAT, a 4G RAT, and/or a RAT subsequent to 5G (e.g., 6G).

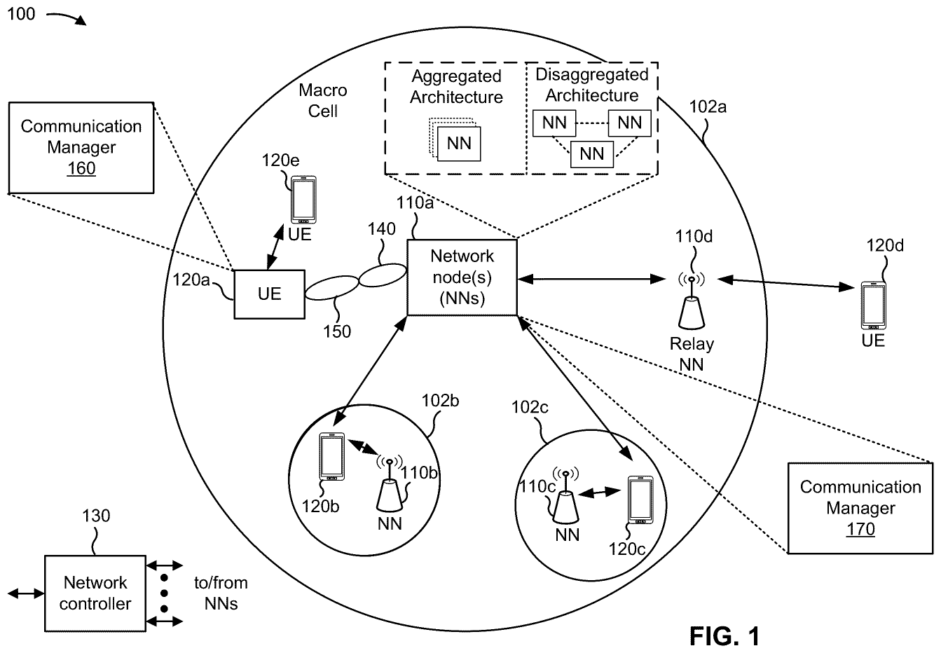

FIG. 1 is a diagram illustrating an example of a wireless network 100, in accordance with the present disclosure. The wireless network 100 may be or may include elements of a 5G (e.g., NR) network and/or a 4G (e.g., Long Term Evolution (LTE)) network, among other examples. The wireless network 100 may include one or more network nodes 110 (shown as a network node 110a, a network node 110b, a network node 110c, and a network node 110d), a UE 120 or multiple UEs 120 (shown as a UE 120a, a UE 120b, a UE 120c, a UE 120d, and a UE 120e), and/or other entities. A network node 110 is a network node that communicates with UEs 120. As shown, a network node 110 may include one or more network nodes. For example, a network node 110 may be an aggregated network node, meaning that the aggregated network node is configured to utilize a radio protocol stack that is physically or logically integrated within a single radio access network (RAN) node (e.g., within a single device or unit). As another example, a network node 110 may be a disaggregated network node (sometimes referred to as a disaggregated base station), meaning that the network node 110 is configured to utilize a protocol stack that is physically or logically distributed among two or more nodes (such as one or more central units (CUs), one or more distributed units (DUs), or one or more radio units (RUs)).

In some examples, a network node 110 is or includes a network node that communicates with UEs 120 via a radio access link, such as an RU. In some examples, a network node 110 is or includes a network node that communicates with other network nodes 110 via a fronthaul link or a midhaul link, such as a DU. In some examples, a network node 110 is or includes a network node that communicates with other network nodes 110 via a midhaul link or a core network via a backhaul link, such as a CU. In some examples, a network node 110 (such as an aggregated network node 110 or a disaggregated network node 110) may include multiple network nodes, such as one or more RUs, one or more CUs, and/or one or more DUs. A network node 110 may include, for example, an NR base station, an LTE base station, a Node B, an eNB (e.g., in 4G), a gNB (e.g., in 5G), an access point, a transmission reception point (TRP), a DU, an RU, a CU, a mobility element of a network, a core network node, a network element, a network equipment, a RAN node, or a combination thereof. In some examples, the network nodes 110 may be interconnected to one another or to one or more other network nodes 110 in the wireless network 100 through various types of fronthaul, midhaul, and/or backhaul interfaces, such as a direct physical connection, an air interface, or a virtual network, using any suitable transport network.

In some examples, a network node 110 may provide communication coverage for a particular geographic area. In the Third Generation Partnership Project (3GPP), the term “cell” can refer to a coverage area of a network node 110 and/or a network node subsystem serving this coverage area, depending on the context in which the term is used. A network node 110 may provide communication coverage for a macro cell, a pico cell, a femto cell, and/or another type of cell. A macro cell may cover a relatively large geographic area (e.g., several kilometers in radius) and may allow unrestricted access by UEs 120 with service subscriptions. A pico cell may cover a relatively small geographic area and may allow unrestricted access by UEs 120 with service subscriptions. A femto cell may cover a relatively small geographic area (e.g., a home) and may allow restricted access by UEs 120 having association with the femto cell (e.g., UEs 120 in a closed subscriber group (CSG)). A network node 110 for a macro cell may be referred to as a macro network node. A network node 110 for a pico cell may be referred to as a pico network node. A network node 110 for a femto cell may be referred to as a femto network node or an in-home network node. In the example shown in FIG. 1, the network node 110a may be a macro network node for a macro cell 102a, the network node 110b may be a pico network node for a pico cell 102b, and the network node 110c may be a femto network node for a femto cell 102c. A network node may support one or multiple (e.g., three) cells. In some examples, a cell may not necessarily be stationary, and the geographic area of the cell may move according to the location of a network node 110 that is mobile (e.g., a mobile network node).

In some aspects, the terms “base station” or “network node” may refer to an aggregated base station, a disaggregated base station, an integrated access and backhaul (IAB) node, a relay node, or one or more components thereof. For example, in some aspects, “base station” or “network node” may refer to a CU, a DU, an RU, a Near-Real Time (Near-RT) RAN Intelligent Controller (RIC), or a Non-Real Time (Non-RT) RIC, or a combination thereof. In some aspects, the terms “base station” or “network node” may refer to one device configured to perform one or more functions, such as those described herein in connection with the network node 110. In some aspects, the terms “base station” or “network node” may refer to a plurality of devices configured to perform the one or more functions. For example, in some distributed systems, each of a quantity of different devices (which may be located in the same geographic location or in different geographic locations) may be configured to perform at least a portion of a function, or to duplicate performance of at least a portion of the function, and the terms “base station” or “network node” may refer to any one or more of those different devices. In some aspects, the terms “base station” or “network node” may refer to one or more virtual base stations or one or more virtual base station functions. For example, in some aspects, two or more base station functions may be instantiated on a single device. In some aspects, the terms “base station” or “network node” may refer to one of the base station functions and not another. In this way, a single device may include more than one base station.

The wireless network 100 may include one or more relay stations. A relay station is a network node that can receive a transmission of data from an upstream node (e.g., a network node 110 or a UE 120) and send a transmission of the data to a downstream node (e.g., a UE 120 or a network node 110). A relay station may be a UE 120 that can relay transmissions for other UEs 120. In the example shown in FIG. 1, the network node 110d (e.g., a relay network node) may communicate with the network node 110a (e.g., a macro network node) and the UE 120d in order to facilitate communication between the network node 110a and the UE 120d. A network node 110 that relays communications may be referred to as a relay station, a relay base station, a relay network node, a relay node, a relay, or the like.

The wireless network 100 may be a heterogeneous network that includes network nodes 110 of different types, such as macro network nodes, pico network nodes, femto network nodes, relay network nodes, or the like. These different types of network nodes 110 may have different transmit power levels, different coverage areas, and/or different impacts on interference in the wireless network 100. For example, macro network nodes may have a high transmit power level (e.g., 5 to 40 watts) whereas pico network nodes, femto network nodes, and relay network nodes may have lower transmit power levels (e.g., 0.1 to 2 watts).

A network controller 130 may couple to or communicate with a set of network nodes 110 and may provide coordination and control for these network nodes 110. The network controller 130 may communicate with the network nodes 110 via a backhaul communication link or a midhaul communication link. The network nodes 110 may communicate with one another directly or indirectly via a wireless or wireline backhaul communication link. In some aspects, the network controller 130 may be a CU or a core network device, or may include a CU or a core network device.

The UEs 120 may be dispersed throughout the wireless network 100, and each UE 120 may be stationary or mobile. A UE 120 may include, for example, an access terminal, a terminal, a mobile station, and/or a subscriber unit. A UE 120 may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device, a biometric device, a wearable device (e.g., a smart watch, smart clothing, smart glasses, a smart wristband, smart jewelry (e.g., a smart ring or a smart bracelet)), an entertainment device (e.g., a music device, a video device, and/or a satellite radio), a vehicular component or sensor, a smart meter/sensor, industrial manufacturing equipment, a global positioning system device, a UE function of a network node, and/or any other suitable device that is configured to communicate via a wireless or wired medium.

Some UEs 120 may be considered machine-type communication (MTC) or evolved or enhanced machine-type communication (eMTC) UEs. An MTC UE and/or an eMTC UE may include, for example, a robot, a drone, a remote device, a sensor, a meter, a monitor, and/or a location tag, that may communicate with a network node, another device (e.g., a remote device), or some other entity. Some UEs 120 may be considered Internet-of-Things (IoT) devices, and/or may be implemented as NB-IoT (narrowband IoT) devices. Some UEs 120 may be considered a Customer Premises Equipment. A UE 120 may be included inside a housing that houses components of the UE 120, such as processor components and/or memory components. In some examples, the processor components and the memory components may be coupled together. For example, the processor components (e.g., one or more processors) and the memory components (e.g., a memory) may be operatively coupled, communicatively coupled, electronically coupled, and/or electrically coupled.

In general, any number of wireless networks 100 may be deployed in a given geographic area. Each wireless network 100 may support a particular RAT and may operate on one or more frequencies. A RAT may be referred to as a radio technology, an air interface, or the like. A frequency may be referred to as a carrier, a frequency channel, or the like. Each frequency may support a single RAT in a given geographic area in order to avoid interference between wireless networks of different RATs. In some cases, NR or 5G RAT networks may be deployed.

In some examples, two or more UEs 120 (e.g., shown as UE 120a and UE 120e) may communicate directly using one or more sidelink channels (e.g., without using a network node 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, or a vehicle-to-pedestrian (V2P) protocol), and/or a mesh network. In such examples, a UE 120 may perform scheduling operations, resource selection operations, and/or other operations described elsewhere herein as being performed by the network node 110.

Devices of the wireless network 100 may communicate using the electromagnetic spectrum, which may be subdivided by frequency or wavelength into various classes, bands, channels, or the like. For example, devices of the wireless network 100 may communicate using one or more operating bands. In 5G NR, two initial operating bands have been identified as frequency range designations FR1 (410 MHz-7.125 GHz) and FR2 (24.25 GHz-52.6 GHz). It should be understood that although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (37 GHz-48.2 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 50 GHz. For example, three higher operating bands have been identified as frequency range designations FR4a or FR4-1 (52.6 GHz-71 GHz), FR4 (52.6 GHz-114.25 GHz), and FR5 (114.25 GHz-300 GHz). Each of these higher frequency bands falls within the EHF band.

With the above examples in mind, unless specifically stated otherwise, it should be understood that the term “sub-6 GHz” or the like, if used herein, may broadly represent frequencies that may be less than 6 GHz, may be within FR1, or may include mid-band frequencies. Further, unless specifically stated otherwise, it should be understood that the term “millimeter wave” or the like, if used herein, may broadly represent frequencies that may include mid-band frequencies, may be within FR2, FR4, FR4-a or FR4-1, and/or FR5, or may be within the EHF band. It is contemplated that the frequencies included in these operating bands (e.g., FR1, FR2, FR3, FR4, FR4-a, FR4-1, and/or FR5) may be modified, and techniques described herein are applicable to those modified frequency ranges.

As further shown in FIG. 1, a network node 110 may communicate with a UE 120 via one or more network node (NN) beams 140. The UE 120 may communicate with the network node 110 via one or more UE beams 150. The one or more NN beams 140 may be wide NN beams, narrow NN beams, or a combination thereof. The one or more UE beams 150 may be wide UE beams, narrow UE beams, or a combination thereof.

“Wide beam” refers to a wireless communication beam that has not been refined and/or that is associated with a small beamforming gain. A wide beam may also be referred to as an unrefined beam. “Narrow beam” refers to a wireless communication beam that is highly directional and has a high beamforming gain. A narrow beam may also be referred to as a refined beam. While wide beams may generally provide greater coverage, narrow beams may provide higher throughput and lower latency, among other examples. A wide beam may spread the transmit power of a network node across a greater geographic coverage area relative to a narrow beam. A narrow beam may focus the transmit power of a network node in a relatively small geographic area (e.g., relative to a wide beam), which enables a greater amount of the transmit power (and thus, a greater throughput) to be directed toward a particular UE. Due to the smaller geographic or spatial coverage of a narrow beam relative to a wide beam, a narrow beam may enable a greater amount of beams to be used, which may provide additional spatial diversity across different beams relative to a wide beam.

In some aspects, the UE 120 may include a communication manager 160. As described in more detail elsewhere herein, the communication manager 160 may transmit, via a transceiver and to a network node, an indication of a capability to support high rank MIMO communication on two or more frequency bands that have a common intermediate frequency, where the capability to support the high rank MIMO communications includes a capability to support MIMO communication in approximately a same direction and on greater than two layers; and perform, via the transceiver, the high rank MIMO communication with the network node on the two or more frequency bands in approximately the same direction. Additionally, or alternatively, the communication manager 160 may perform one or more other operations described herein.

In some aspects, the network node 110 may include a communication manager 170. As described in more detail elsewhere herein, the communication manager 170 may receive, from a UE, an indication of a capability of the UE to support high rank MIMO communication on two or more frequency bands that have a common intermediate frequency, where the capability to support the high rank MIMO communication includes a capability to support MIMO communication in approximately a same direction and on greater than two layers; and may perform the high rank MIMO communication with the UE on the two or more frequency bands in approximately the same direction. Additionally, or alternatively, the communication manager 170 may perform one or more other operations described herein.

As indicated above, FIG. 1 is provided as an example. Other examples may differ from what is described with regard to FIG. 1.

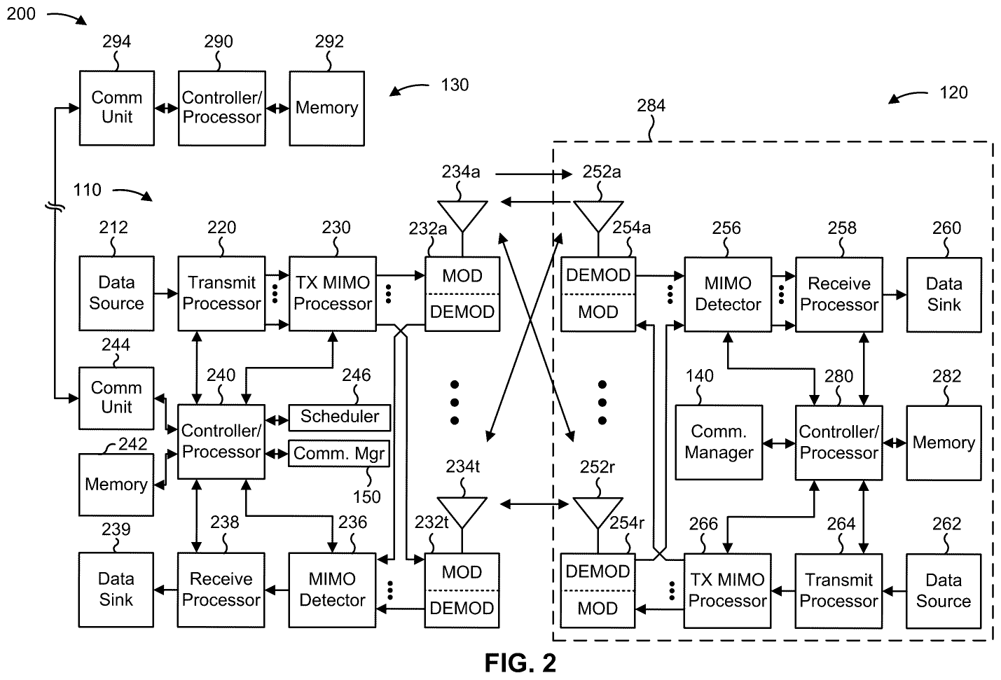

FIG. 2 is a diagram illustrating an example 200 of a network node 110 in communication with a UE 120 in a wireless network 100, in accordance with the present disclosure. The network node 110 may be equipped with a set of antennas 234a through 234t, such as T antennas (T≥1). The UE 120 may be equipped with a set of antennas 252a through 252r, such as R antennas (R≥1). The network node 110 of example 200 includes one or more radio frequency components, such as antennas 234 and a modem 232. In some examples, a network node 110 may include an interface, a communication component, or another component that facilitates communication with the UE 120 or another network node. Some network nodes 110 may not include radio frequency components that facilitate direct communication with the UE 120, such as one or more CUs, or one or more DUs.

At the network node 110, a transmit processor 220 may receive data, from a data source 212, intended for the UE 120 (or a set of UEs 120). The transmit processor 220 may select one or more modulation and coding schemes (MCSs) for the UE 120 based at least in part on one or more channel quality indicators (CQIs) received from that UE 120. The network node 110 may process (e.g., encode and modulate) the data for the UE 120 based at least in part on the MCS(s) selected for the UE 120 and may provide data symbols for the UE 120. The transmit processor 220 may process system information (e.g., for semi-static resource partitioning information (SRPI)) and control information (e.g., CQI requests, grants, and/or upper layer signaling) and provide overhead symbols and control symbols. The transmit processor 220 may generate reference symbols for reference signals (e.g., a cell-specific reference signal (CRS) or a demodulation reference signal (DMRS)) and synchronization signals (e.g., a primary synchronization signal (PSS) or a secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide a set of output symbol streams (e.g., T output symbol streams) to a corresponding set of modems 232 (e.g., T modems), shown as modems 232a through 232t. For example, each output symbol stream may be provided to a modulator component (shown as MOD) of a modem 232. Each modem 232 may use a respective modulator component to process a respective output symbol stream (e.g., for OFDM) to obtain an output sample stream. Each modem 232 may further use a respective modulator component to process (e.g., convert to analog, amplify, filter, and/or upconvert) the output sample stream to obtain a downlink signal. The modems 232a through 232t may transmit a set of downlink signals (e.g., T downlink signals) via a corresponding set of antennas 234 (e.g., T antennas), shown as antennas 234a through 234t.

At the UE 120, a set of antennas 252 (shown as antennas 252a through 252r) may receive the downlink signals from the network node 110 and/or other network nodes 110 and may provide a set of received signals (e.g., R received signals) to a set of modems 254 (e.g., R modems), shown as modems 254a through 254r. For example, each received signal may be provided to a demodulator component (shown as DEMOD) of a modem 254. Each modem 254 may use a respective demodulator component to condition (e.g., filter, amplify, downconvert, and/or digitize) a received signal to obtain input samples. Each modem 254 may use a demodulator component to further process the input samples (e.g., for OFDM) to obtain received symbols. A MIMO detector 256 may obtain received symbols from the modems 254, may perform MIMO detection on the received symbols if applicable, and may provide detected symbols. A receive processor 258 may process (e.g., demodulate and decode) the detected symbols, may provide decoded data for the UE 120 to a data sink 260, and may provide decoded control information and system information to a controller/processor 280. The term “controller/processor” may refer to one or more controllers, one or more processors, or a combination thereof. A channel processor may determine a reference signal received power (RSRP) parameter, a received signal strength indicator (RSSI) parameter, a reference signal received quality (RSRQ) parameter, and/or a CQI parameter, among other examples. In some examples, one or more components of the UE 120 may be included in a housing 284.

The network controller 130 may include a communication unit 294, a controller/processor 290, and a memory 292. The network controller 130 may include, for example, one or more devices in a core network. The network controller 130 may communicate with the network node 110 via the communication unit 294.

One or more antennas (e.g., antennas 234a through 234t and/or antennas 252a through 252r) may include, or may be included within, one or more antenna panels, one or more antenna groups, one or more sets of antenna elements, and/or one or more antenna arrays, among other examples. An antenna panel, an antenna group, a set of antenna elements, and/or an antenna array may include one or more antenna elements (within a single housing or multiple housings), a set of coplanar antenna elements, a set of non-coplanar antenna elements, and/or one or more antenna elements coupled to one or more transmission and/or reception components, such as one or more components of FIG. 2.

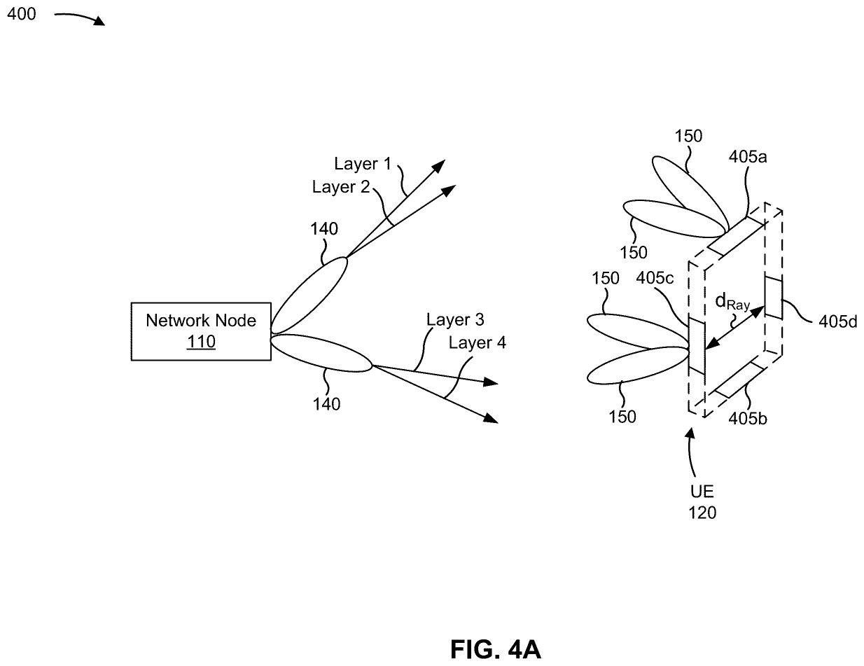

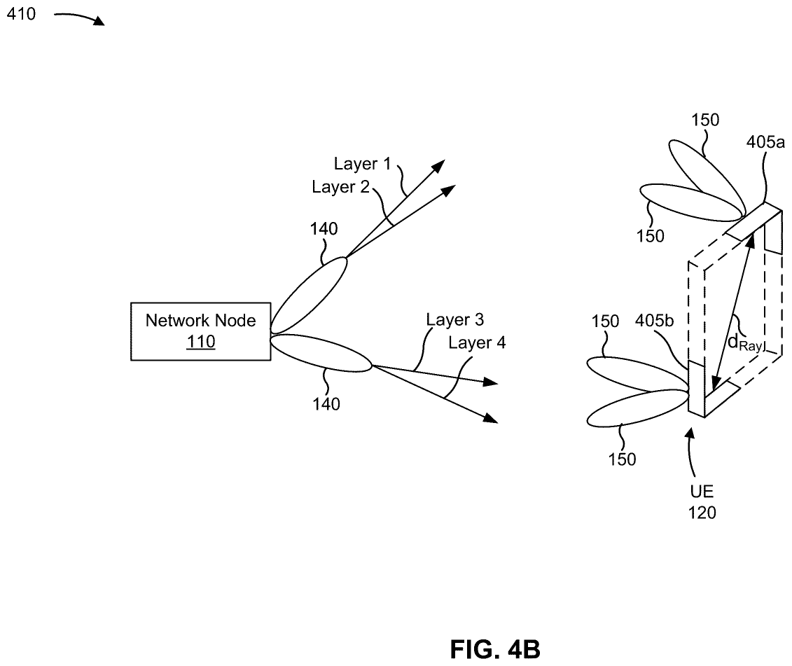

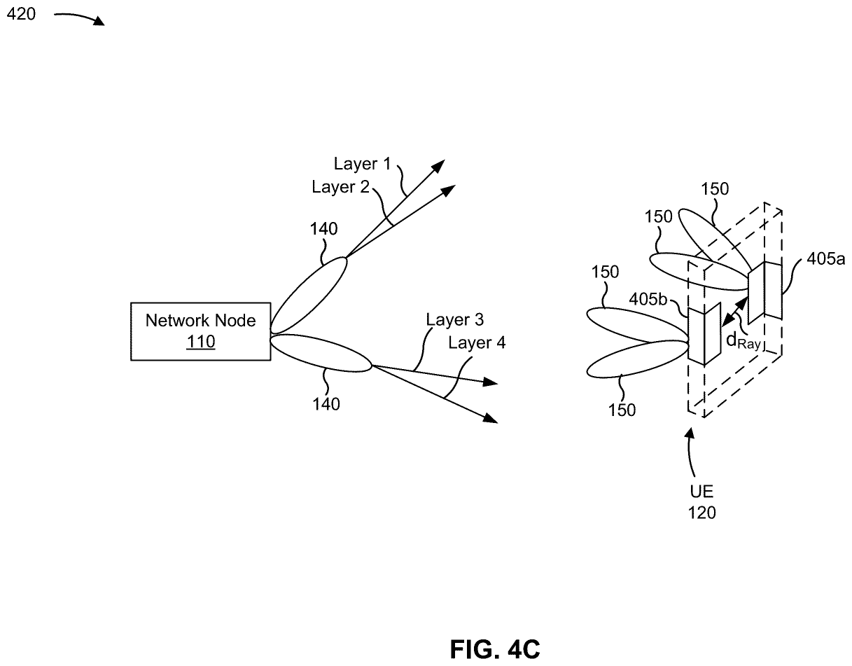

On the uplink, at the UE 120, a transmit processor 264 may receive and process data from a data source 262 and control information (e.g., for reports that include RSRP, RSSI, RSRQ, and/or CQI) from the controller/processor 280. The transmit processor 264 may generate reference symbols for one or more reference signals. The symbols from the transmit processor 264 may be precoded by a TX MIMO processor 266 if applicable, further processed by the modems 254 (e.g., for DFT-s-OFDM or CP-OFDM), and transmitted to the network node 110. In some examples, the modem 254 of the UE 120 may include a modulator and a demodulator. In some examples, the UE 120 includes a transceiver. The transceiver may include any combination of the antenna(s) 252, the modem(s) 254, the MIMO detector 256, the receive processor 258, the transmit processor 264, and/or the TX MIMO processor 266. The transceiver may be used by a processor (e.g., the controller/processor 280) and the memory 282 to perform aspects of any of the methods described herein (e.g., with reference to FIGS. 4A-10).

At the network node 110, the uplink signals from UE 120 and/or other UEs may be received by the antennas 234, processed by the modem 232 (e.g., a demodulator component, shown as DEMOD, of the modem 232), detected by a MIMO detector 236 if applicable, and further processed by a receive processor 238 to obtain decoded data and control information sent by the UE 120. The receive processor 238 may provide the decoded data to a data sink 239 and provide the decoded control information to the controller/processor 240. The network node 110 may include a communication unit 244 and may communicate with the network controller 130 via the communication unit 244. The network node 110 may include a scheduler 246 to schedule one or more UEs 120 for downlink and/or uplink communications. In some examples, the modem 232 of the network node 110 may include a modulator and a demodulator. In some examples, the network node 110 includes a transceiver. The transceiver may include any combination of the antenna(s) 234, the modem(s) 232, the MIMO detector 236, the receive processor 238, the transmit processor 220, and/or the TX MIMO processor 230. The transceiver may be used by a processor (e.g., the controller/processor 240) and the memory 242 to perform aspects of any of the methods described herein (e.g., with reference to FIGS. 4A-10).

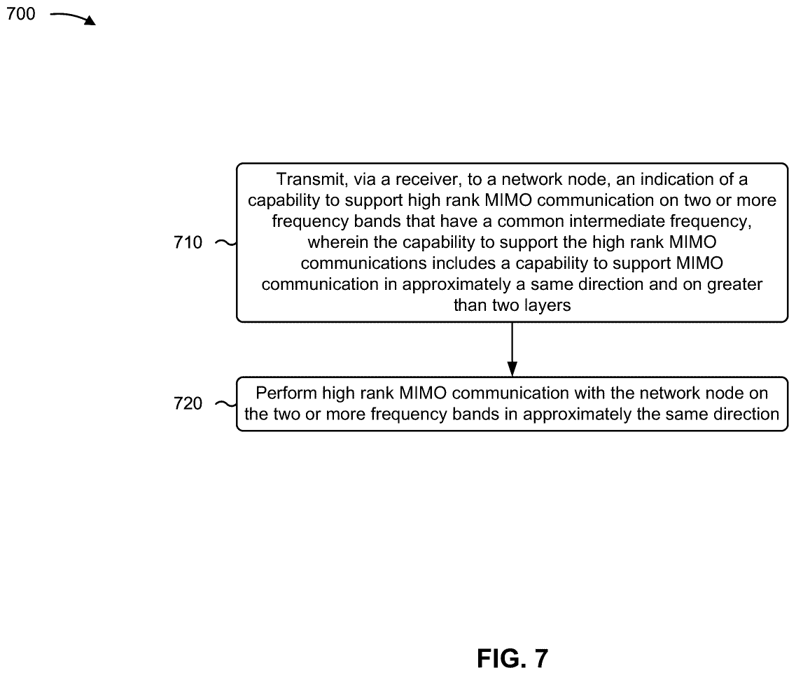

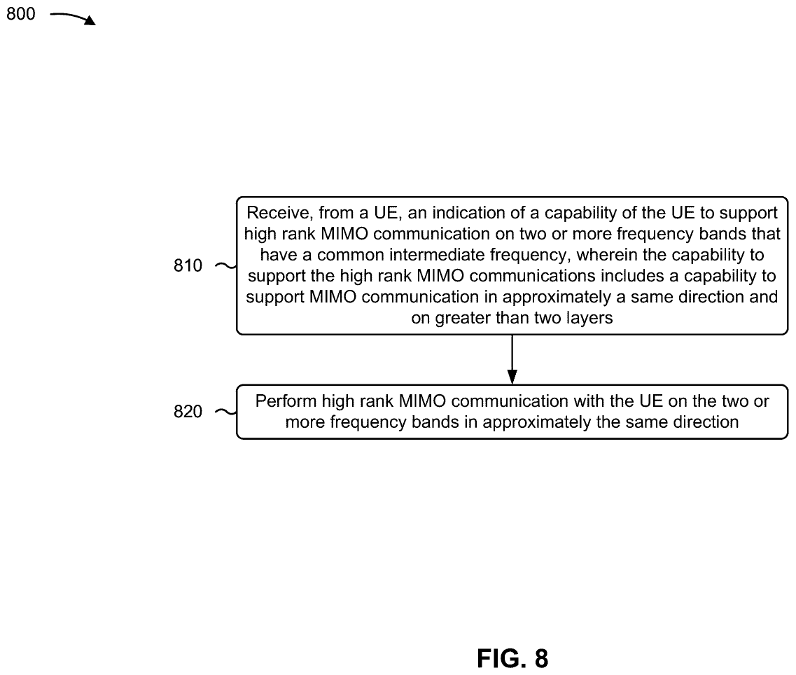

The controller/processor 240 of the network node 110, the controller/processor 280 of the UE 120, and/or any other component(s) of FIG. 2 may perform one or more techniques associated with high rank multiple input multiple output for multi-band antenna module wireless communication devices, as described in more detail elsewhere herein. For example, the controller/processor 240 of the network node 110, the controller/processor 280 of the UE 120, and/or any other component(s) of FIG. 2 may perform or direct operations of, for example, process 700 of FIG. 7, process 800 of FIG. 8, and/or other processes as described herein. The memory 242 and the memory 282 may store data and program codes for the network node 110 and the UE 120, respectively. In some examples, the memory 242 and/or the memory 282 may include a non-transitory computer-readable medium storing one or more instructions (e.g., code and/or program code) for wireless communication. For example, the one or more instructions, when executed (e.g., directly, or after compiling, converting, and/or interpreting) by one or more processors of the network node 110 and/or the UE 120, may cause the one or more processors, the UE 120, and/or the network node 110 to perform or direct operations of, for example, process 700 of FIG. 7, process 800 of FIG. 8, and/or other processes as described herein. In some examples, executing instructions may include running the instructions, converting the instructions, compiling the instructions, and/or interpreting the instructions, among other examples.

In some aspects, the UE 120 includes means for transmitting (e.g., using controller/processor 280, transmit processor 264, TX MIMO processor 266, modem 254, antenna 252, memory 282, or the like), to a network node, an indication of a capability to support high rank MIMO communication on two or more frequency bands that have a common intermediate frequency, wherein the capability to support the high rank MIMO communication includes a capability to support MIMO communication in approximately a same direction and on greater than two layers; and/or means for performing (e.g., using controller/processor 280, transmit processor 264, TX MIMO processor 266, modem 254, antenna 252, MIMO detector 256, receive processor 258, memory 282, or the like) the high rank MIMO communication with the network node on the two or more frequency bands in approximately the same direction. The means for the UE 120 to perform operations described herein may include, for example, one or more of communication manager 160, antenna 252, modem 254, MIMO detector 256, receive processor 258, transmit processor 264, TX MIMO processor 266, controller/processor 280, or memory 282.

In some aspects, the network node 110 includes means for receiving (e.g., using antenna 234, modem 232, MIMO detector 236, receive processor 238, controller/processor 240, memory 242, or the like), from a UE 120, an indication of a capability of the UE 120 to support high rank MIMO communication on two or more frequency bands that have a common intermediate frequency, wherein the capability to support the high rank MIMO communication includes a capability to support MIMO communication in approximately a same direction and on greater than two layers; and/or means for performing (e.g., using transmit processor 220, TX MIMO processor 230, modem 232, antenna 234, MIMO detector 236, receive processor 238, controller/processor 240, memory 242, or the like) the high rank MIMO communication with the UE on the two or more frequency bands in approximately the same direction. The means for the network node to perform operations described herein may include, for example, one or more of communication manager 170, transmit processor 220, TX MIMO processor 230, modem 232, antenna 234, MIMO detector 236, receive processor 238, controller/processor 240, memory 242, or scheduler 246.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of the controller/processor 280.

As indicated above, FIG. 2 is provided as an example. Other examples may differ from what is described with regard to FIG. 2.

Deployment of communication systems, such as 5G NR systems, may be arranged in multiple manners with various components or constituent parts. In a 5G NR system, or network, a network node, a network entity, a mobility element of a network, a RAN node, a core network node, a network element, a base station, or a network equipment may be implemented in an aggregated or disaggregated architecture. For example, a base station (such as a Node B (NB), an evolved NB (eNB), an NR base station, a 5G NB, an access point (AP), a TRP, or a cell, among other examples), or one or more units (or one or more components) performing base station functionality, may be implemented as an aggregated base station (also known as a standalone base station or a monolithic base station) or a disaggregated base station. “Network entity” or “network node” may refer to a disaggregated base station, or to one or more units of a disaggregated base station (such as one or more CUs, one or more DUs, one or more RUs, or a combination thereof).

An aggregated base station (e.g., an aggregated network node) may be configured to utilize a radio protocol stack that is physically or logically integrated within a single RAN node (e.g., within a single device or unit). A disaggregated base station (e.g., a disaggregated network node) may be configured to utilize a protocol stack that is physically or logically distributed among two or more units (such as one or more CUs, one or more DUs, or one or more RUs). In some examples, a CU may be implemented within a network node, and one or more DUs may be co-located with the CU, or alternatively, may be geographically or virtually distributed throughout one or multiple other network nodes. The DUs may be implemented to communicate with one or more RUs. Each of the CU, DU, and RU also can be implemented as virtual units, such as a virtual central unit (VCU), a virtual distributed unit (VDU), or a virtual radio unit (VRU), among other examples.

Base station-type operation or network design may consider aggregation characteristics of base station functionality. For example, disaggregated base stations may be utilized in an IAB network, an open radio access network (O-RAN (such as the network configuration sponsored by the O-RAN Alliance)), or a virtualized radio access network (vRAN, also known as a cloud radio access network (C-RAN)) to facilitate scaling of communication systems by separating base station functionality into one or more units that can be individually deployed. A disaggregated base station may include functionality implemented across two or more units at various physical locations, as well as functionality implemented for at least one unit virtually, which can enable flexibility in network design. The various units of the disaggregated base station can be configured for wired or wireless communication with at least one other unit of the disaggregated base station.

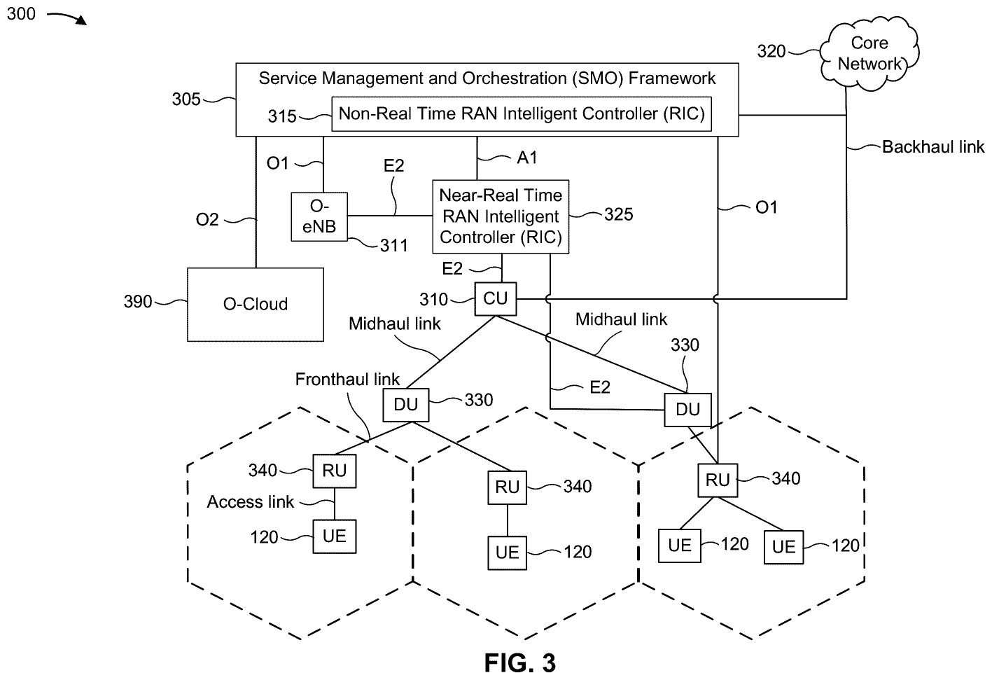

FIG. 3 is a diagram illustrating an example disaggregated base station architecture 300, in accordance with the present disclosure. The disaggregated base station architecture 300 may include a CU 310 that can communicate directly with a core network 320 via a backhaul link, or indirectly with the core network 320 through one or more disaggregated control units (such as a Near-RT RIC 325 via an E2 link, or a Non-RT RIC 315 associated with a Service Management and Orchestration (SMO) Framework 305, or both). A CU 310 may communicate with one or more DUs 330 via respective midhaul links, such as through F1 interfaces. Each of the DUs 330 may communicate with one or more RUs 340 via respective fronthaul links. Each of the RUs 340 may communicate with one or more UEs 120 via respective radio frequency (RF) access links. In some implementations, a UE 120 may be simultaneously served by multiple RUs 340.

Each of the units, including the CUs 310, the DUs 330, the RUs 340, as well as the Near-RT RICs 325, the Non-RT RICs 315, and the SMO Framework 305, may include one or more interfaces or be coupled with one or more interfaces configured to receive or transmit signals, data, or information (collectively, signals) via a wired or wireless transmission medium. Each of the units, or an associated processor or controller providing instructions to one or multiple communication interfaces of the respective unit, can be configured to communicate with one or more of the other units via the transmission medium. In some examples, each of the units can include a wired interface, configured to receive or transmit signals over a wired transmission medium to one or more of the other units, and a wireless interface, which may include a receiver, a transmitter or transceiver (such as an RF transceiver), configured to receive or transmit signals, or both, over a wireless transmission medium to one or more of the other units.

In some aspects, the CU 310 may host one or more higher layer control functions. Such control functions can include radio resource control (RRC) functions, packet data convergence protocol (PDCP) functions, or service data adaptation protocol (SDAP) functions, among other examples. Each control function can be implemented with an interface configured to communicate signals with other control functions hosted by the CU 310. The CU 310 may be configured to handle user plane functionality (for example, Central Unit-User Plane (CU-UP) functionality), control plane functionality (for example, Central Unit-Control Plane (CU-CP) functionality), or a combination thereof. In some implementations, the CU 310 can be logically split into one or more CU-UP units and one or more CU-CP units. A CU-UP unit can communicate bidirectionally with a CU-CP unit via an interface, such as the E1 interface when implemented in an O-RAN configuration. The CU 310 can be implemented to communicate with a DU 330, as necessary, for network control and signaling.

Each DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers depending, at least in part, on a functional split, such as a functional split defined by the 3GPP. In some aspects, the one or more high PHY layers may be implemented by one or more modules for forward error correction (FEC) encoding and decoding, scrambling, and modulation and demodulation, among other examples. In some aspects, the DU 330 may further host one or more low PHY layers, such as implemented by one or more modules for a fast Fourier transform (FFT), an inverse FFT (iFFT), digital beamforming, or physical random access channel (PRACH) extraction and filtering, among other examples. Each layer (which also may be referred to as a module) can be implemented with an interface configured to communicate signals with other layers (and modules) hosted by the DU 330, or with the control functions hosted by the CU 310.

Each RU 340 may implement lower-layer functionality. In some deployments, an RU 340, controlled by a DU 330, may correspond to a logical node that hosts RF processing functions or low-PHY layer functions, such as performing an FFT, performing an iFFT, digital beamforming, or PRACH extraction and filtering, among other examples, based on a functional split (for example, a functional split defined by the 3GPP), such as a lower layer functional split. In such an architecture, each RU 340 can be operated to handle over the air (OTA) communication with one or more UEs 120. In some implementations, real-time and non-real-time aspects of control and user plane communication with the RU(s) 340 can be controlled by the corresponding DU 330. In some scenarios, this configuration can enable each DU 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements, which may be managed via an operations and maintenance interface (such as an O1 interface). For virtualized network elements, the SMO Framework 305 may be configured to interact with a cloud computing platform (such as an open cloud (O-Cloud) platform 390) to perform network element life cycle management (such as to instantiate virtualized network elements) via a cloud computing platform interface (such as an O2 interface). Such virtualized network elements can include, but are not limited to, CUs 310, DUs 330, RUs 340, non-RT RICs 315, and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with each of one or more RUs 340 via a respective O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via an O1 interface) or via creation of RAN management policies (such as A1 interface policies).

As indicated above, FIG. 3 is provided as an example. Other examples may differ from what is described with regard to FIG. 3.

FIGS. 4A-4C are diagrams of examples of high rank MIMO communication, in accordance with the present disclosure. As shown in FIGS. 4A-4C, high rank MIMO communication may be performed between a network node 110 and a UE 120. The network node 110 and the UE 120 may be included in a wireless network, such as the wireless network 100.

As shown in an example 400 in FIG. 4A, the network node 110 may communicate with the UE 120 via one or more NN beams 140 and the UE 120 may communicate with the network node 110 via one or more UE beams 150. In some aspects, more than one beam with an associated rank (e.g., more than one NN beam 140, more than one UE beam 150) may be used for high rank MIMO simultaneously to support wireless communication on more than two layers (e.g., Layer 1 through Layer 4).

In some aspects, two or more layers (e.g., spatial layers, polarization layers) are supported on each beam. For example, Layer 1 and Layer 2 may be used on a first NN beam 140 and on a first UE beam 150, and Layer 3 and Layer 4 may be used on a second NN beam 140 and on a second UE beam 150. In some aspects, Layer 1 and Layer 2 may be used by the network node 110 and the UE 120 for higher rank MIMO communication on a first frequency band (e.g., an FR2 frequency band), and Layer 3 and Layer 4 may be used by the network node 110 and the UE 120 for higher rank MIMO communication on a second frequency band (e.g., an FR3 frequency band, an FR4 frequency band).

As further shown in FIG. 4A, the UE 120 may include a plurality of multi-band antenna modules 405, such as multi-band antenna modules 405a-405d. The multi-band antenna modules 405 may be located on one or more sides, one or more ends, and/or another location on the housing 284 of the UE 120 to achieve good spherical coverage, to provide module level diversity, and/or to overcome limited reception capabilities, among other examples. For example, a multi-band antenna module 405a may be located on a first side of the housing 284 of the UE 120, and a multi-band antenna module 405c may be located on a second side of the housing 284 of the UE 120, where the first side and the second side are approximately orthogonal sides of the housing 284 of the UE. Other examples of orthogonal sides may include a face (e.g., a back face) of the housing 284 of the UE 120 and a top side of the housing 284 of the UE 120, and/or a bottom side of the housing 284 of the UE 120 and a left side (or a right side) of the housing 284 of the UE 120, among other examples.

As another example, a multi-band antenna module 405a may be located on a first side of the housing 284 of the UE 120, and a multi-band antenna module 405b may be located on a second side of the housing 284 of the UE 120, where the first side and the second side are opposing sides of the housing 284 of the UE. Other examples of opposing sides may include a back face of the housing 284 of the UE 120, a left side of the housing 284 of the UE 120 and/or a right side of the housing 284 of the UE 120, and/or a bottom side of the housing 284 of the UE 120 and a top side of the housing 284 of the UE 120, among other examples.

Each multi-band antenna module 405 may include a plurality of antennas 252 (or a plurality of antenna elements). For example, a multi-band antenna module may include a first set of antennas 252 (or antenna elements) that are configured for wireless communication on a first frequency band (e.g., an FR2 frequency band), and may include a second set of antennas 252 (or antenna elements) that are configured for wireless communication on a second frequency band (e.g., an FR3 frequency band, an FR4 frequency band). “FR2 frequency band” refers to a frequency band within the FR2 frequency range, “FR3 frequency band” refers to a frequency band within the FR3 frequency range, and “FR4 frequency band” refers to a frequency band within the FR4 frequency range, and so on.

In some aspects, the different sets of antennas 252 (or antenna elements) of a multi-band antenna module 405 that are used across different frequencies may have approximately a same boresight direction, which may enable inter-band carrier aggregation (CA) and/or inter-band dual connectivity (DC) over different frequency bands.

Two or more of the multi-band antenna modules 405a-405d may be configured for high rank MIMO communication on two or more frequency bands in approximately a same direction. In other words, the two or more of the multi-band antenna modules 405a-405d may be configured to transmit communications to and/or to receive communications from the network node 110 in approximately a same spatial direction. For example, the two or more of the multi-band antenna modules 405a-405d may be configured to transmit communications to and/or to receive communications from the network node 110 within less than 90 degrees of spatial separation. Thus, the UE beams 150 via which communications are transmitted and/or received by the multi-band antenna modules 405a and 405c, for example, may be refined to provide coverage in approximately a same spatial direction (e.g., as opposed to omnidirectional coverage or coverage in different spatial directions).

As further shown in FIG. 4A, two or more of the multi-band antenna modules 405a-405d may be physically spaced apart by a Rayleigh distance (d_{Ray}), which refers to a threshold distance (e.g., a minimum separation distance) between the two or more of the multi-band antenna modules 405a-405d so that the two or more of the multi-band antenna modules 405a-405d appear to be uncorrelated by the network node 110. If the distance between multi-band antenna modules is less than the Rayleigh distance, correlation may increase proportionately. However, spectral efficiency gains can be realized as long as the correlation coefficient satisfies a threshold value.

The Rayleigh distance (d_{Ray}) for two or more of the multi-band antenna modules 405a-405d may be determined as:

$${d}_{Ray} = \sqrt{\frac{R λ}{N}}$$

where X is the wavelength of propagation of the frequency band used for wireless communication between the network node 110 and the UE 120, R is the separation distance between the antenna modules of the UE 120 and the antenna modules of the network node 110, and N is the quantity of antenna elements of the network node 110. The above equation can be used in a similar manner to determine the spacing between antenna modules of the network node 110 to achieve uncorrelation at the UE 120.

As the frequency that is used between the network node 110 and the UE 120 for wireless communication increases (which is related to X in the Rayleigh distance equation above), the inter-antenna separation for achieving uncorrelation decreases. Thus, uncorrelation for higher frequencies in FR3, FR4, and beyond may be more easily achieved, particularly in UEs and other small form factor wireless communication devices. For example, for a 6 GHz frequency, where N=4, and R=100 meters, the Rayleigh distance (d_{Ray}) may be approximately 1.1 meters; for a 30 GHz frequency, where N=4, and R=100 meters, the Rayleigh distance (d_{Ray}) may be approximately 0.5 meters; and for a 120 GHz frequency, where N=4, and R=100 meters, the Rayleigh distance (d_{Ray}) may be approximately 0.25 meters. With N=64 at 120 GHz, this distance becomes 0.0625 m or 62.5 mm.

FIG. 4B illustrates an example 410 in which one or more of the multi-band antenna modules of the UE 120 that wrap around an edge or a corner of the UE 120. For example, a multi-band antenna module 405a may wrap around a corner of the UE 120 such that the multi-band antenna module 405a is located on a left side of the housing 284 of the UE 120 and on a bottom side of the housing 284 of the UE 120. As another example, a multi-band antenna module 405b may wrap around a corner of the UE 120 such that the multi-band antenna module 405b is located on a right side of the housing 284 of the UE 120 and on a top side of the housing 284 of the UE 120.

FIG. 4C illustrates an example 420 in which one or more of the multi-band antenna modules of the UE 120 that wrap around an edge or a corner of the UE 120. For example, a multi-band antenna module 405a may wrap around an edge of the UE 120 such that the multi-band antenna module 405a is located on a right side of the housing 284 of the UE 120 and on a front face of the housing 284 of the UE 120. As another example, a multi-band antenna module 405b may wrap around an edge of the UE 120 such that the multi-band antenna module 405b is located on a left side of the housing 284 of the UE 120 and on a back face of the housing 284 of the UE 120.

As indicated above, FIGS. 4A-4C are provided as examples. Other examples may differ from what is described with regard to FIGS. 4A-4C. The example configurations of multi-band antenna modules 405a-405d are a non-exhaustive set of examples, and other example configurations of multi-band antenna modules 405a-405d are within the scope of the present disclosure. Moreover, UEs 120 that include a greater quantity or a lesser quantity of multi-band antenna modules 405a-405d are within the scope of the present disclosure.

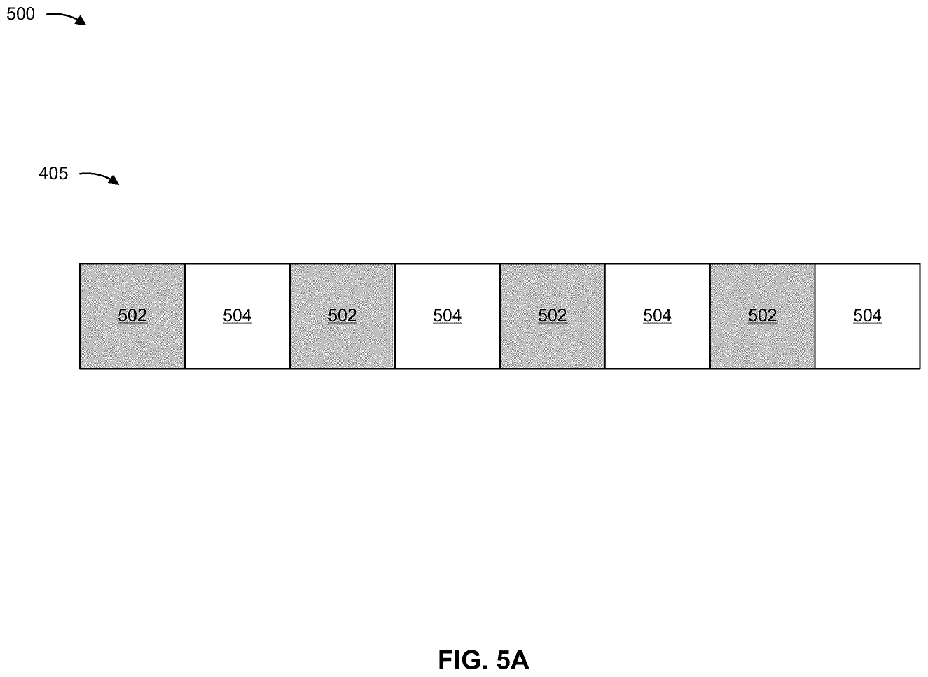

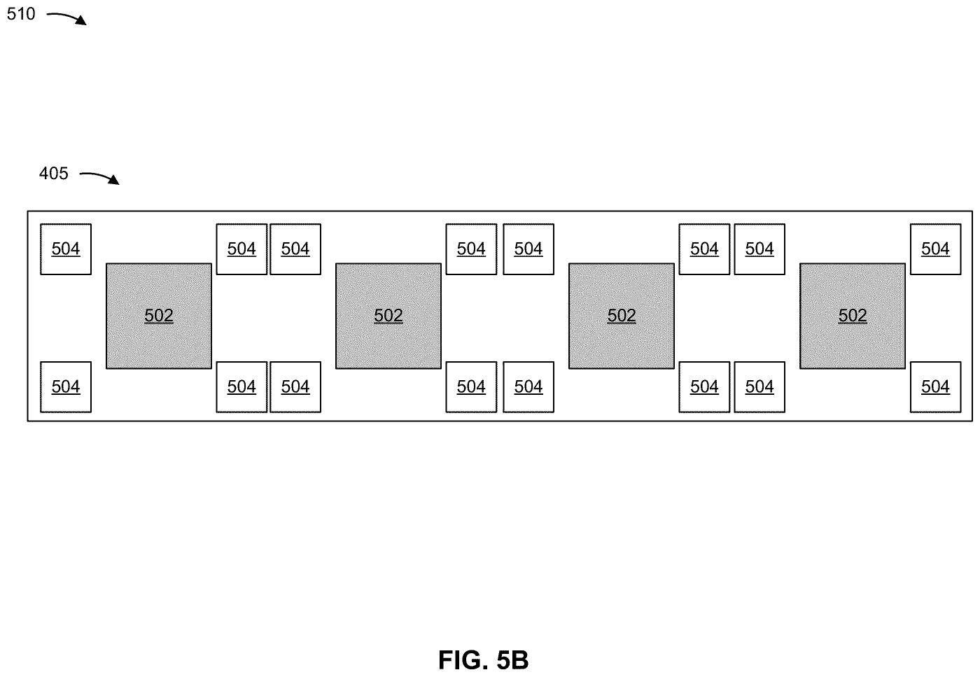

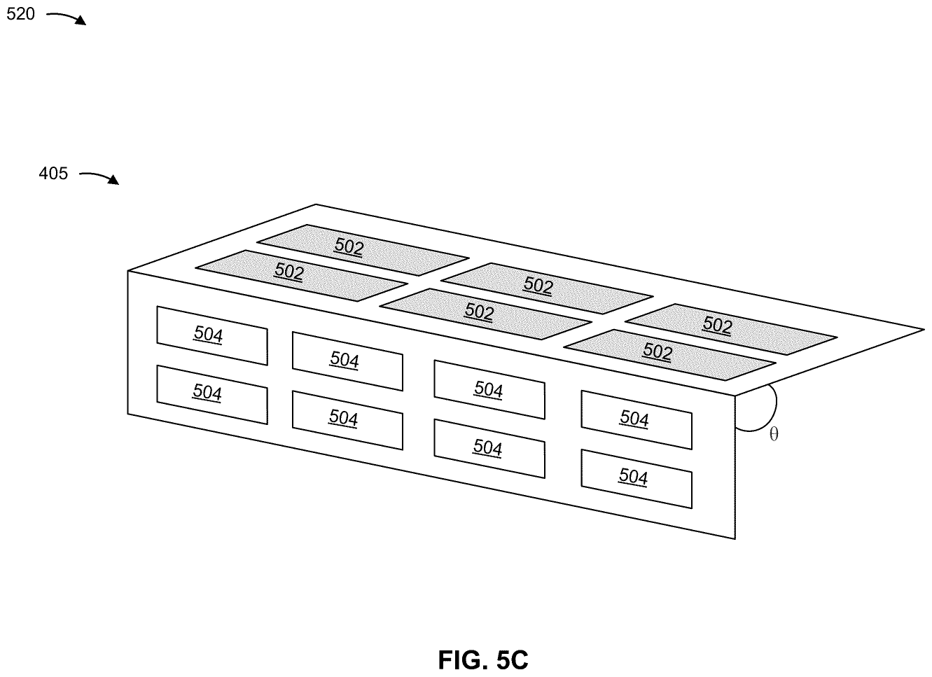

FIGS. 5A-5C are diagrams of examples of multi-band antenna modules 405 for high rank MIMO communication, in accordance with the present disclosure. The examples of antenna modules 405 may be included in a UE 120, a network node 110, and/or another wireless communication device that is configured for high rank MIMO communication in a wireless network.

FIG. 5A illustrates an example 500 of a multi-band antenna module 405 in which low-band antenna elements 502 (e.g., antennas 252) and mid-to-high (mid/high) band antenna elements 504 (e.g., antennas 252) are included on a same substrate and/or are printed with a planar printed circuit board (PCB) process. The example 500 of the multi-band antenna module 405 may be used in the example multi-band antenna module configuration illustrated in FIG. 4A.

The low-band antenna elements 502 may be configured for wireless communication on an FR2 frequency band, an FR1 frequency band, and/or another low-band frequency band. For example, the low-band antenna elements 502 may be configured for wireless communication on a frequency band in a range of approximately 24 GHz to approximately 29.5 GHz. As another example, the low-band antenna elements 502 may be configured for wireless communication on a frequency band in a range of approximately 28 GHz to approximately 39 GHz. In some aspects, the low-band antenna elements 502 may be dual pol phased and configured for wireless communication on two or more interlaced frequency bands, such as 28 GHz and 39 GHz.

The mid/high-band antenna elements 504 may be configured for wireless communication on an FR3 frequency band, an FR4 frequency band, and/or another mid/high band frequency band. For example, the mid/high-band antenna elements 504 may be configured for wireless communication on a frequency band in a range of approximately 57 GHz to approximately 71 GHz. As another example, the mid/high-band antenna elements 504 may be configured for wireless communication on a frequency band in a range of approximately 37 GHz to approximately 43.5 GHz. As another example, the mid/high-band antenna elements 504 may be configured for wireless communication on a frequency band in a range of approximately 47.2 GHz to approximately 48.2 GHz.

As further shown in FIG. 5A, the low-band antenna elements 502 and the mid/high-band antenna elements 504 may be arranged in a row on a substrate. The low-band antenna elements 502 may be configured in a 4×1 array (e.g., an array of 1 row that includes 4 antenna elements) or another array configuration. The mid/high-band antenna elements 504 may be configured in a 4×1 array (e.g., an array of 1 row that includes 4 antenna elements) or another array configuration. The low-band antenna elements 502 and the mid/high-band antenna elements 504 may be arranged in an alternating configuration in the row on the substrate.

As shown in an example 510 of a multi-band antenna module 405 in FIG. 5B, the mid/high-band antenna elements 504 may be located at or near the corners of the low-band antenna elements 502. The low-band antenna elements 502 may be configured in a 4×1 array (e.g., an array of 1 row that includes 4 antenna elements) or another array configuration. The mid/high-band antenna elements 504 may be configured in an 8×2 array (e.g., an array of 2 rows that each include 8 antenna elements) or another array configuration.

FIG. 5C illustrates an example 520 of a multi-band antenna module 405 in which the low-band antenna elements 502 and the mid/high band antenna elements 504 are included on different substrates and are in different planes. For example, the low-band antenna elements 502 may be included on a first substrate that is located in a first plane, and the mid/high band antenna elements 504 may be included on a second substrate that is located in a second plane. In some aspects, the first plane and the second plane may be approximately orthogonal planes. In some aspects, the first plane and the second plane may be separated by another angle (θ).

The example 520 of the multi-band antenna module 405 enables the multi-band antenna module 405 to wrap around a corner or an edge (e.g., of the housing 284 of the UE 120) such that the multi-band antenna module 405 can be located on two sides and/or faces of a wireless communication device. For example, the example 520 of the multi-band antenna module 405 may be used in the example multi-band antenna module configurations illustrated in FIGS. 4B and 4C.

As indicated above, FIGS. 5A-5C are provided as examples. Other examples may differ from what is described with regard to FIGS. 5A-5C.

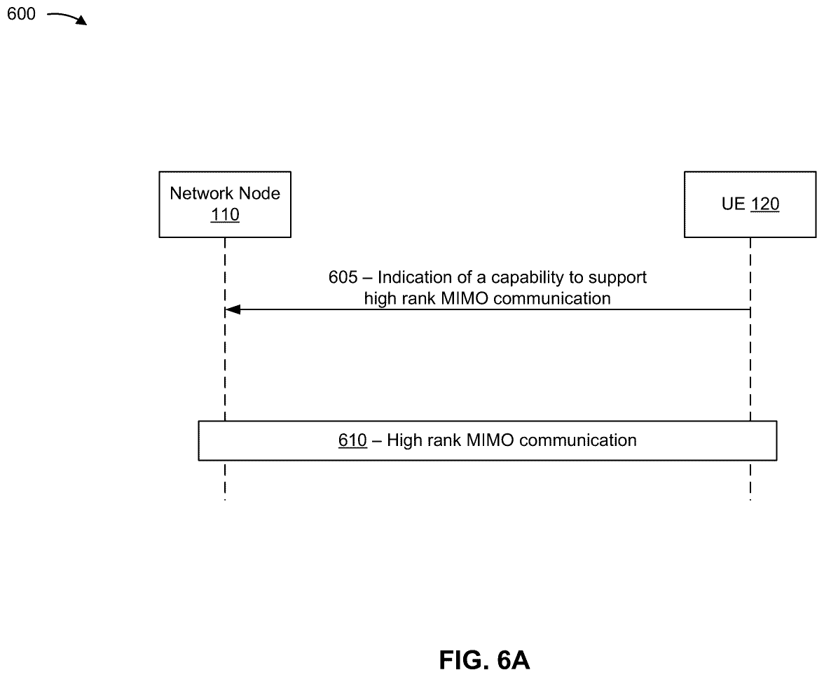

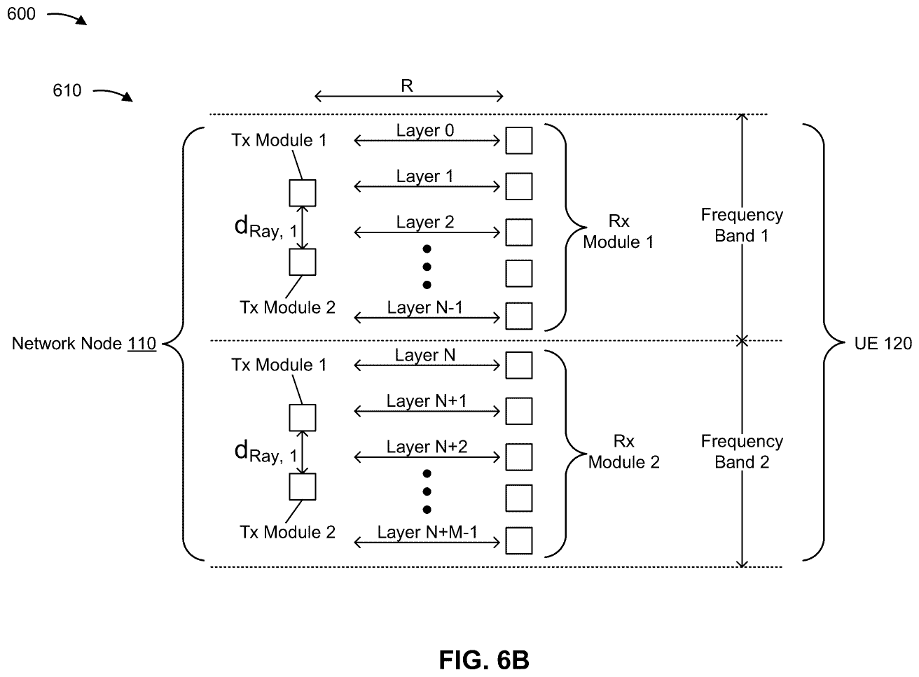

FIGS. 6A and 6B are diagrams of an example 600 of capability signaling for supporting high rank MIMO communication, in accordance with the present disclosure. As shown in FIGS. 6A and 6B, the example 600 may include communication between a network node 110 and a UE 120. The network node 110 and the UE 120 may be included in a wireless network, such as the wireless network 100. The network node 110 and/or the UE 120 may include one or more multi-band antenna modules 405 that enable high rank MIMO communication between the network node 110 and the UE 120. The one or more multi-band antenna modules 405 may be configured as illustrated in one or more of the examples illustrated and described in connection with FIGS. 4A-4C and/or FIGS. 5A-5C, among other examples.

As shown in FIG. 6A, at 605, the UE 120 may transmit an indication of a capability to support high rank MIMO communication. The indication of the capability to support high rank MIMO communication may facilitate the network node 110 in scheduling and/or configuring high rank MIMO communication between the network node 110 and the UE 120. In some aspects, the indication of the capability to support high rank MIMO communication may include an indication of a capability to support high rank MIMO communication on two or more frequency bands, that have a common intermediate frequency, in approximately a same direction. The two or more frequency bands may include, for example, a first frequency band (e.g., an FR2 frequency band or a frequency band in another frequency range) and a second frequency band (e.g., an FR3 frequency band, an FR4 frequency band, or a frequency band in another frequency range). The capability to support high rank MIMO communications includes a capability to support MIMO communications on greater than two (often polarization) layers.

In some aspects, the UE 120 may transmit the indication of the capability to support high rank MIMO communication on the two or more frequency bands, that have the common intermediate frequency, in approximately the same direction based at least in part on a spatial separation between a first multi-band antenna module 405 and a second multi-band antenna module 405 satisfying a spatial separation threshold. The spatial separation threshold may correspond to the Rayleigh distance (d_{Ray}) for either the first frequency band or the second frequency band between the first multi-band antenna module 405 and the second multi-band antenna module 405. The UE 120 may determine that the Rayleigh distance is satisfied for the first multi-band antenna module 405 and the second multi-band antenna module 405 by determining the Rayleigh distance (e.g., based at least in part on the Rayleigh distance equation above), comparing the spatial separation between the first multi-band antenna module 405 and the second multi-band antenna module 405 with the Rayleigh distance, and determining whether the spatial separation satisfies the Rayleigh distance (for the first or second bands) based at least in part on the comparison.

In some aspects, the UE 120 may transmit (e.g., in addition to the indication of the capability) an indication of a quantity of hybrid beamforming sets of beam weights to be supported for high rank MIMO communication. The hybrid beamforming sets of beam weights may be used for RF/analog precoding. In this way, the indication of the quantity of hybrid beamforming sets of beam weights may enable the network node 110 to select particular beam weights for RF/analog precoding for high rank MIMO communication. To support high rank MIMO communication, the quantity of hybrid beamforming sets of beam weights to be supported may be greater than 2 to enable communication on greater than 2 layers (e.g., spatial layers, polarization layers).

In some aspects, the UE 120 may measure and/or determine the spatial separation of at least two multi-band antenna modules 405 of the UE 120 used for high rank MIMO in a plane orthogonal to the propagation direction of the signals between the UE 120 and the network node 110. If the UE 120 determines that there are greater than 2 multi-band antenna modules 405 that can receive the same beam over a higher-rank (e.g., over a rank greater than 2), then the UE 120 reports (e.g., along with the indication of the capability) either all the possible spatial separations or a subset of the possible spatial separations. In some aspects, the UE 120 reports the largest possible spatial separation to the network node 110.

In some aspects, a rank indication generally includes an indication of the associated DMRS ports. The UE 120 may transmit (e.g., in addition to the indication of the capability) an indication of a plurality of DMRS ports associated with a hybrid beamforming set of beam weights to be supported for high rank MIMO communication.

In some aspects, high rank MIMO rate gains come at a tradeoff with increased power consumption. Accordingly, the UE 120 may transmit (e.g., in addition to the indication of the capability) an indication of one or more power and performance parameters for the high rank MIMO communication. The UE 120 may report (e.g., along with the indication of the capability) the power and performance tradeoff parameters to enable selection of high rank MIMO communication parameters by the network node 110.

At 610 in FIG. 6A, the network node 110 and/or the UE 120 may perform high rank MIMO communication based at least in part on the indication of the capability at 605. For example, the network node 110 may receive the indication of the capability from the UE 120 and may schedule, configure, and/or enable high rank MIMO communication for the UE 120 based at least in part on the indication of the capability. The network node 110 and/or the UE 120 may perform high rank MIMO communication with the network node on the two or more frequency bands (e.g., that share the same intermediate frequency) in approximately the same direction.

In some aspects, the high rank MIMO communication may include performing high rank MIMO communication on a first frequency band, of the two or more frequency bands, using a first subset of antenna elements (e.g., antenna elements 502) on a first multi-band antenna module 405 and a first subset of antenna elements (e.g., antenna elements 502) on a second multi-band antenna module 405. In some aspects, the high rank MIMO communication may include performing high rank MIMO communication on a second frequency band, of the two or more frequency bands, using a second subset of antenna elements (e.g., antenna elements 504) on the first multi-band antenna module 405, and a second subset of antenna elements (e.g., antenna elements 504) on the second multi-band antenna module 405.

In some aspects, the high rank MIMO communication includes performing high rank MIMO communication on a first frequency band, of the two or more frequency bands, using a first plurality of antenna elements (e.g., antenna elements 502) on a first multi-band antenna module 405, and performing high rank MIMO communication on a second frequency band, of the two or more frequency bands, using a second plurality of antenna elements (e.g., antenna elements 504) on a second multi-band antenna module 405.

In some aspects, the high rank MIMO communication includes performing high rank MIMO communication on the first frequency band via two or more first spatial layers (e.g., Layer 1 and Layer 2), and performing high rank MIMO communication on the second frequency band via two or more second spatial layers (e.g., Layer 3 and Layer 4).

FIG. 6B illustrates a detailed example configuration of the high rank MIMO communication at 610. As shown in FIG. 6B, the high rank MIMO communication may occur on two or more frequency bands (e.g., Frequency Band 1, Frequency Band 2) that share a common intermediate frequency. The antenna elements of the multi-band antenna modules 405 of the network node 110 and/or of the UE 120 may have approximately a same boresight, approximately a same coverage direction, and/or approximately a same region, among other examples.

As shown in FIG. 6B, a Tx Module 1 (e.g., a first multi-band antenna module 405) of the network node 110 and a Tx Module 2 (e.g., a second multi-band antenna module 405) of the network node 110 may be spaced apart by a first Rayleigh distance (d_{Ray,1}) to enable uncorrelation at the UE 120. A Tx Module 3 (e.g., a third multi-band antenna module 405) of the network node 110 and a Tx Module 4 (e.g., a fourth multi-band antenna module 405) of the network node 110 may be spaced apart by a second Rayleigh distance (d_{Ray,2}) to enable uncorrelation at the UE 120.

As further shown in FIG. 6B, the Tx Module 1 and the Tx Module 2 may communicate with an Rx Module 1 (e.g., a first multi-band antenna module 405) on the Frequency Band 1. The Tx Module 3 and the Tx Module 4 may communicate with an Rx Module 2 (e.g., a second multi-band antenna module 405) on the Frequency Band 2.

The Tx Modules 1 and 2, and the Rx Module 1 may communicate via a first plurality of layers, Layer 0 through Layer N−1 (e.g., spatial layers, polarization layers). The Tx Modules 3 and 4, and the Rx Module 2 may communicate via a second plurality of layers (Layer N through Layer N+M−1). The quantity of layers Layer 0 through Layer N+M−1 may be greater than 2 layers, which enables high rank MIMO communication between the network node 110 and the UE 120.

As indicated above, FIGS. 6A and 6B are provided as an example. Other examples may differ from what is described with regard to FIGS. 6A and 6B.

FIG. 7 is a diagram illustrating an example process 700 performed, for example, by a UE, in accordance with the present disclosure. Example process 700 is an example where the UE (e.g., UE 120) performs operations associated with high rank multiple input multiple output communication for multi-band antenna module wireless communication devices.

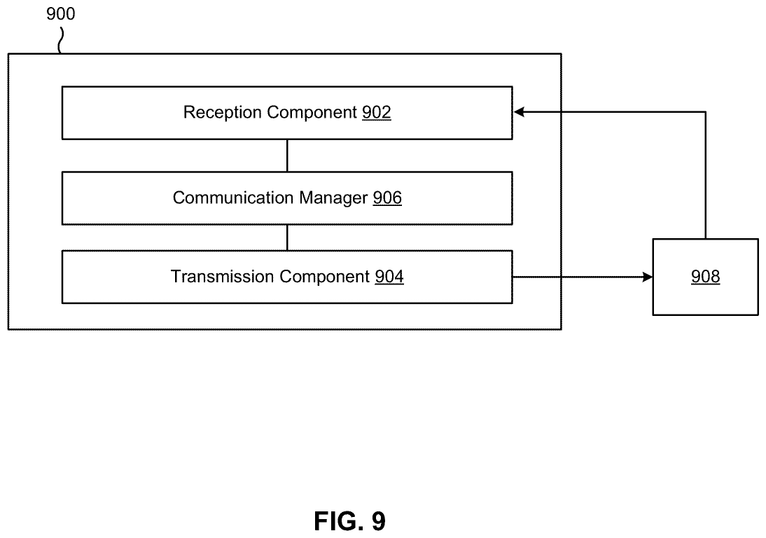

As shown in FIG. 7, in some aspects, process 700 may include transmitting, via a transceiver of the UE and to a network node, an indication of a capability to support high rank MIMO communication on two or more frequency bands that have a common intermediate frequency, wherein the capability to support the high rank MIMO communication includes a capability to support MIMO communication in approximately a same direction and on greater than two layers (block 710). For example, the UE (e.g., using communication manager 160 and/or transmission component 904, depicted in FIG. 9) may transmit, via a transceiver of the UE to a network node, an indication of a capability to support high rank MIMO communication on two or more frequency bands that have a common intermediate frequency, as described above, for example, with reference to FIGS. 4A, 4B, 4C, 6A, and/or 6B, among other examples. In some aspects, the capability to support the high rank MIMO communication includes a capability to support MIMO communication in approximately a same direction and on greater than two layers (e.g., spatial layers, polarization layers).

As further shown in FIG. 7, in some aspects, process 700 may include performing high rank MIMO communication with the network node on the two or more frequency bands in approximately the same direction (block 720). For example, the UE (e.g., using communication manager 160, reception component 902, and/or transmission component 904, depicted in FIG. 9) may perform high rank MIMO communication with the network node on the two or more frequency bands in approximately the same direction, as described above, for example, with reference to FIGS. 4A, 4B, 4C, 6A, and/or 6B, among other examples.

Process 700 may include additional aspects, such as any single aspect or any combination of aspects described below and/or in connection with one or more other processes described elsewhere herein.

In a first aspect, performing, via the transceiver, the high rank MIMO communication with the network node on the two or more frequency bands in approximately the same direction comprises performing the high rank MIMO communication with the network node on a first frequency band, of the two or more frequency bands, using a first subset of antenna elements on a first antenna module associated with the transceiver of the UE, and a first subset of antenna elements on a second antenna module of the UE, and performing, via the transceiver, high rank MIMO communication with the network node on a second frequency band, of the two or more frequency bands, using a second subset of antenna elements on a first antenna module of the UE, and a second subset of antenna elements on a second antenna module associated with the transceiver of the UE.

In a second aspect, alone or in combination with the first aspect, the first frequency band comprises an FR2 frequency band, and the second frequency band comprises an FR3 frequency band or an FR4 frequency band.

In a third aspect, alone or in combination with one or more of the first and second aspects, the first antenna module is located on a first side of the UE, wherein the second antenna module is located on a second side of the UE, and wherein the first side and the second side are opposing sides of the UE.

In a fourth aspect, alone or in combination with one or more of the first through third aspects, the first antenna module is located on a first side of the UE, wherein the second antenna module is located on a second side of the UE, and wherein the first side and the second side are approximately orthogonal sides of the UE.

In a fifth aspect, alone or in combination with one or more of the first through fourth aspects, performing, via the transceiver, the high rank MIMO communication with the network node on the first frequency band comprises performing, via the transceiver, the high rank MIMO communication with the network node on the first frequency band via two or more first spatial layers, and performing, via the transceiver, the high rank MIMO communication with the network node on the second frequency band via two or more second spatial layers.

In a sixth aspect, alone or in combination with one or more of the first through fifth aspects, transmitting, via the transceiver, the indication of the capability to support the high rank MIMO communication comprises transmitting, via the transceiver, the indication of the capability to support the high rank MIMO communication based at least in part on a spatial separation between the first antenna module and the second antenna module satisfying a spatial separation threshold.

In a seventh aspect, alone or in combination with one or more of the first through sixth aspects, performing, via the transceiver, the high rank MIMO communication comprises performing, via the transceiver, the high rank MIMO communication with the network node on a first frequency band, of the two or more frequency bands, using a first plurality of antenna elements on a first antenna module associated with the transceiver of the UE, and performing, via the transceiver, the high rank MIMO communication with the network node on a second frequency band, of the two or more frequency bands, using a second plurality of antenna elements on a second antenna module associated with the transceiver of the UE.

In an eighth aspect, alone or in combination with one or more of the first through seventh aspects, the first frequency band comprises an FR2 frequency band, and the second frequency band comprises an FR3 frequency band or an FR4 frequency band.

In a ninth aspect, alone or in combination with one or more of the first through eighth aspects, the first antenna module is located on a first side of the UE, wherein the second antenna module is located on a second side of the UE, and wherein the first side and the second side are opposing sides of the UE.

In a tenth aspect, alone or in combination with one or more of the first through ninth aspects, the first antenna module is located on a first side of the UE, wherein the second antenna module is located on a second side of the UE, and wherein the first side and the second side are approximately orthogonal sides of the UE.

In an eleventh aspect, alone or in combination with one or more of the first through tenth aspects, performing, via the transceiver, the high rank MIMO communication with the network node on the first frequency band comprises performing, via the transceiver, the high rank MIMO communication with the network node on the first frequency band via two or more first spatial layers, and performing, via the transceiver, the high rank MIMO communication with the network node on the second frequency band via two or more second spatial layers.

In a twelfth aspect, alone or in combination with one or more of the first through eleventh aspects, transmitting, via the transceiver, the indication of the capability to support the high rank MIMO communication comprises transmitting, via the transceiver, the indication of the capability to support the high rank MIMO communication based at least in part on a spatial separation between the first antenna module and the second antenna module satisfying a spatial separation threshold.

In a thirteenth aspect, alone or in combination with one or more of the first through twelfth aspects, transmitting, via the transceiver, the indication of the capability to support the high rank MIMO communication comprises transmitting an indication of a quantity of hybrid beamforming sets of beam weights to be supported for the high rank MIMO communication.

In a fourteenth aspect, alone or in combination with one or more of the first through thirteenth aspects, the quantity of hybrid beamforming sets of beam weights to be supported is greater than 2.

In a fifteenth aspect, alone or in combination with one or more of the first through fourteenth aspects, transmitting, via the transceiver, the indication of the capability to support the high rank MIMO communication comprises transmitting an indication of a plurality of DMRS ports associated with a hybrid beamforming set of beam weights to be supported for the high rank MIMO communication.

In a sixteenth aspect, alone or in combination with one or more of the first through fifteenth aspects, transmitting, via the transceiver, the indication of the capability to support the high rank MIMO communication comprises transmitting an indication of power and performance parameters for the high rank MIMO communication.

Although FIG. 7 shows example blocks of process 700, in some aspects, process 700 may include additional blocks, fewer blocks, different blocks, or differently arranged blocks than those depicted in FIG. 7. Additionally, or alternatively, two or more of the blocks of process 700 may be performed in parallel.

FIG. 8 is a diagram illustrating an example process 800 performed, for example, by a network node, in accordance with the present disclosure. Example process 800 is an example where the network node (e.g., network node 110) performs operations associated with high rank multiple input multiple output communication for multi-band antenna module wireless communication devices.

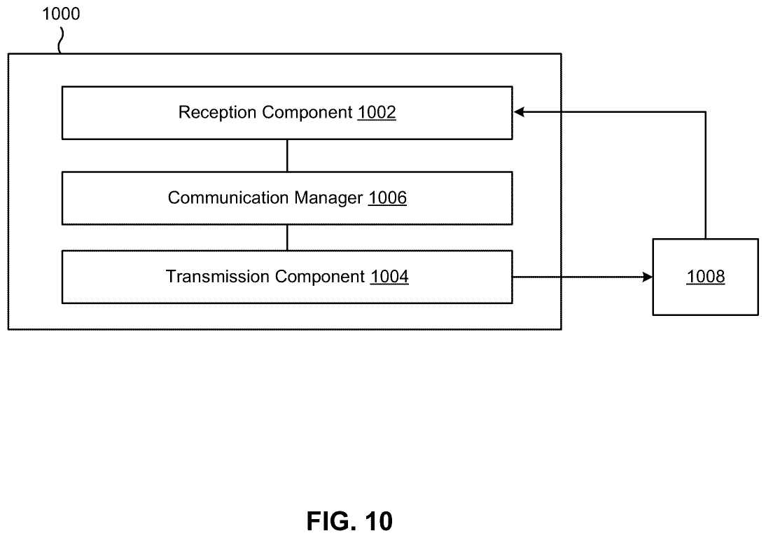

As shown in FIG. 8, in some aspects, process 800 may include receiving, from a UE, an indication of a capability of the UE to support high rank MIMO communication on two or more frequency bands that have a common intermediate frequency, wherein the capability to support the high rank MIMO communication includes a capability to support MIMO communication in approximately a same direction and on greater than two layers (block 810). For example, the network node (e.g., using communication manager 170 and/or reception component 1002, depicted in FIG. 10) may receive, from a UE, an indication of a capability of the UE to support high rank MIMO communication on two or more frequency bands that have a common intermediate frequency, as described above, for example, with reference to FIGS. 4A, 4B, 4C, 6A, and/or 6B, among other examples. In some aspects, the capability to support the high rank MIMO communication includes a capability to support MIMO communication in approximately a same direction and on greater than two layers.

As further shown in FIG. 8, in some aspects, process 800 may include performing the high rank MIMO communication with the UE on the two or more frequency bands in approximately the same direction (block 820). For example, the network node (e.g., using communication manager 170, reception component 1002, and/or transmission component 1004, depicted in FIG. 10) may perform the high rank MIMO communication with the UE on the two or more frequency bands in approximately the same direction, as described above, for example, with reference to FIGS. 4A, 4B, 4C, 6A, and/or 6B, among other examples.

Process 800 may include additional aspects, such as any single aspect or any combination of aspects described below and/or in connection with one or more other processes described elsewhere herein.

In a first aspect, performing the high rank MIMO communication with the UE on the two or more frequency bands in approximately the same direction comprises performing the high rank MIMO communication with the UE on a first frequency band, of the two or more frequency bands, via a first subset of antenna elements on a first antenna module of the UE, and a first subset of antenna elements on a second antenna module of the UE, and performing the high rank MIMO communication with the UE on a second frequency band, of the two or more frequency bands, via a second subset of antenna elements on a first antenna module of the UE, and a second subset of antenna elements on a second antenna module of the UE.

In a second aspect, alone or in combination with the first aspect, the first frequency band comprises an FR2 frequency band, and the second frequency band comprises an FR3 frequency band or an FR4 frequency band.

In a third aspect, alone or in combination with one or more of the first and second aspects, performing the high rank MIMO communication with the UE on the first frequency band comprises performing the high rank MIMO communication with the UE on the first frequency band via two or more first spatial layers, and performing the high rank MIMO communication with the UE on the second frequency band via two or more second spatial layers.

In a fourth aspect, alone or in combination with one or more of the first through third aspects, receiving the indication of the capability to support the high rank MIMO communication on the two or more frequency bands, that have the common intermediate frequency, in approximately the same direction comprises receiving the indication of the capability to support the high rank MIMO communication on the two or more frequency bands, that have the common intermediate frequency, in approximately the same direction based at least in part on a spatial separation between the first antenna module and the second antenna module satisfying a spatial separation threshold.

In a fifth aspect, alone or in combination with one or more of the first through fourth aspects, performing the high rank MIMO communication with the UE on the two or more frequency bands in approximately the same direction comprises performing the high rank MIMO communication with the UE on a first frequency band, of the two or more frequency bands, via a plurality of antenna elements on a first antenna module of the UE, and performing the high rank MIMO communication with the UE on a second frequency band, of the two or more frequency bands, via a second plurality of antenna elements on a second antenna module of the UE.

In a sixth aspect, alone or in combination with one or more of the first through fifth aspects, the first frequency band comprises an FR2 frequency band, and the second frequency band comprises an FR3 frequency band or an FR4 frequency band.

In a seventh aspect, alone or in combination with one or more of the first through sixth aspects, performing the high rank MIMO communication with the UE on the first frequency band comprises performing the high rank MIMO communication with the UE on the first frequency band via two or more first spatial layers, and performing the high rank MIMO communication with the UE on the second frequency band via two or more second spatial layers.

In an eighth aspect, alone or in combination with one or more of the first through seventh aspects, transmitting the indication of the capability to support the high rank MIMO communication on the two or more frequency bands, that have the common intermediate frequency, in approximately the same direction comprises receiving the indication of the capability to support the high rank MIMO communication on the two or more frequency bands, that have the common intermediate frequency, in approximately the same direction based at least in part on a spatial separation between the first antenna module and the second antenna module satisfying a spatial separation threshold.

In a ninth aspect, alone or in combination with one or more of the first through eighth aspects, receiving the indication of the capability to support the high rank MIMO communication on the two or more frequency bands in approximately the same direction comprises receiving an indication of a quantity of hybrid beamforming sets of beam weights to be supported for the high rank MIMO communication.

In a tenth aspect, alone or in combination with one or more of the first through ninth aspects, the quantity of hybrid beamforming sets of beam weights to be supported is greater than 2.

In an eleventh aspect, alone or in combination with one or more of the first through tenth aspects, receiving the indication of the capability to support high rank the MIMO communication on the two or more frequency bands in approximately the same direction comprises receiving an indication of a plurality of demodulation reference signal (DMRS) ports associated with a hybrid beamforming set of beam weights to be supported for the high rank MIMO communication.

In a twelfth aspect, alone or in combination with one or more of the first through eleventh aspects, receiving the indication of the capability to support the high rank MIMO communication on the two or more frequency bands, that have the common intermediate frequency, in approximately the same direction comprises receiving an indication of power and performance parameters for the high rank MIMO communication.

Although FIG. 8 shows example blocks of process 800, in some aspects, process 800 may include additional blocks, fewer blocks, different blocks, or differently arranged blocks than those depicted in FIG. 8. Additionally, or alternatively, two or more of the blocks of process 800 may be performed in parallel.

FIG. 9 is a diagram of an example apparatus 900 for wireless communication, in accordance with the present disclosure. The apparatus 900 may be a UE 120, or a UE 120 may include the apparatus 900. In some aspects, the apparatus 900 includes a reception component 902, a transmission component 904, and/or a communication manager 906, which may be in communication with one another (for example, via one or more buses and/or one or more other components). In some aspects, the communication manager 906 is the communication manager 160 described in connection with FIG. 1. As shown, the apparatus 900 may communicate with another apparatus 908, such as a UE or a network node (such as a CU, a DU, an RU, or a base station), using the reception component 902 and the transmission component 904.

In some aspects, the apparatus 900 may be configured to perform one or more operations described herein in connection with FIGS. 4A-4C, 6A, and/or 6B, among other examples. Additionally, or alternatively, the apparatus 900 may be configured to perform one or more processes described herein, such as process 700 of FIG. 7, or a combination thereof. In some aspects, the apparatus 900 and/or one or more components shown in FIG. 9 may include one or more components of the UE described in connection with FIG. 2. Additionally, or alternatively, one or more components shown in FIG. 9 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 902 may receive communications, such as reference signals, control information, data communications, or a combination thereof, from the apparatus 908. The reception component 902 may provide received communications to one or more other components of the apparatus 900. In some aspects, the reception component 902 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 900. In some aspects, the reception component 902 may include one or more antennas, a modem, a demodulator, a MIMO detector, a receive processor, a controller/processor, a memory, or a combination thereof, of the UE described in connection with FIG. 2.

The transmission component 904 may transmit communications, such as reference signals, control information, data communications, or a combination thereof, to the apparatus 908. In some aspects, one or more other components of the apparatus 900 may generate communications and may provide the generated communications to the transmission component 904 for transmission to the apparatus 908. In some aspects, the transmission component 904 may perform signal processing on the generated communications (such as filtering, amplification, modulation, digital-to-analog conversion, multiplexing, interleaving, mapping, or encoding, among other examples), and may transmit the processed signals to the apparatus 908. In some aspects, the transmission component 904 may include one or more antennas, a modem, a modulator, a transmit MIMO processor, a transmit processor, a controller/processor, a memory, or a combination thereof, of the UE described in connection with FIG. 2. In some aspects, the transmission component 904 may be co-located with the reception component 902 in a transceiver.

The communication manager 906 may support operations of the reception component 902 and/or the transmission component 904. For example, the communication manager 906 may receive information associated with configuring reception of communications by the reception component 902 and/or transmission of communications by the transmission component 904. Additionally, or alternatively, the communication manager 906 may generate and/or provide control information to the reception component 902 and/or the transmission component 904 to control reception and/or transmission of communications.

The transmission component 904 may transmit, to the apparatus 908, an indication of a capability to support high rank MIMO communication on two or more frequency bands, that have a common intermediate frequency, in approximately a same direction, wherein the capability to support high rank MIMO communications includes a capability to support MIMO communications on greater than two layers. The reception component 902, transmission component 904, and/or communication manager 906, may perform high rank MIMO communication with the apparatus 908 on the two or more frequency bands in approximately the same direction.

The number and arrangement of components shown in FIG. 9 are provided as an example. In practice, there may be additional components, fewer components, different components, or differently arranged components than those shown in FIG. 9. Furthermore, two or more components shown in FIG. 9 may be implemented within a single component, or a single component shown in FIG. 9 may be implemented as multiple, distributed components. Additionally, or alternatively, a set of (one or more) components shown in FIG. 9 may perform one or more functions described as being performed by another set of components shown in FIG. 9.

FIG. 10 is a diagram of an example apparatus 1000 for wireless communication, in accordance with the present disclosure. The apparatus 1000 may be a network node 110, or a network node 110 may include the apparatus 1000. In some aspects, the apparatus 1000 includes a reception component 1002, a transmission component 1004, and/or a communication manager 1006, which may be in communication with one another (for example, via one or more buses and/or one or more other components). In some aspects, the communication manager 1006 is the communication manager 170 described in connection with FIG. 1. As shown, the apparatus 1000 may communicate with another apparatus 1008, such as a UE or a network node (such as a CU, a DU, an RU, or a base station), using the reception component 1002 and the transmission component 1004.

In some aspects, the apparatus 1000 may be configured to perform one or more operations described herein in connection with FIGS. 4A-4C, 6A, and/or 6B, among other examples. Additionally, or alternatively, the apparatus 1000 may be configured to perform one or more processes described herein, such as process 800 of FIG. 8. In some aspects, the apparatus 1000 and/or one or more components shown in FIG. 10 may include one or more components of the network node described in connection with FIG. 2. Additionally, or alternatively, one or more components shown in FIG. 10 may be implemented within one or more components described in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1002 may receive communications, such as reference signals, control information, data communications, or a combination thereof, from the apparatus 1008. The reception component 1002 may provide received communications to one or more other components of the apparatus 1000. In some aspects, the reception component 1002 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1000. In some aspects, the reception component 1002 may include one or more antennas, a modem, a demodulator, a MIMO detector, a receive processor, a controller/processor, a memory, or a combination thereof, of the network node described in connection with FIG. 2. In some aspects, the reception component 1002 and/or the transmission component 1004 may include or may be included in a network interface. The network interface may be configured to obtain and/or output signals for the apparatus 1000 via one or more communications links, such as a backhaul link, a midhaul link, and/or a fronthaul link.

The transmission component 1004 may transmit communications, such as reference signals, control information, data communications, or a combination thereof, to the apparatus 1008. In some aspects, one or more other components of the apparatus 1000 may generate communications and may provide the generated communications to the transmission component 1004 for transmission to the apparatus 1008. In some aspects, the transmission component 1004 may perform signal processing on the generated communications (such as filtering, amplification, modulation, digital-to-analog conversion, multiplexing, interleaving, mapping, or encoding, among other examples), and may transmit the processed signals to the apparatus 1008. In some aspects, the transmission component 1004 may include one or more antennas, a modem, a modulator, a transmit MIMO processor, a transmit processor, a controller/processor, a memory, or a combination thereof, of the network node described in connection with FIG. 2. In some aspects, the transmission component 1004 may be co-located with the reception component 1002 in a transceiver.

The communication manager 1006 may support operations of the reception component 1002 and/or the transmission component 1004. For example, the communication manager 1006 may receive information associated with configuring reception of communications by the reception component 1002 and/or transmission of communications by the transmission component 1004. Additionally, or alternatively, the communication manager 1006 may generate and/or provide control information to the reception component 1002 and/or the transmission component 1004 to control reception and/or transmission of communications.

The reception component 1002 may receive, from the apparatus 1008, an indication of a capability of the apparatus 1008 to support high rank MIMO communication on two or more frequency bands, that have a common intermediate frequency, in approximately a same direction, wherein the capability to support high rank MIMO communications includes a capability to support MIMO communications on greater than two layers. The reception component 1002, transmission component 1004, and/or communication manager 1006 may perform high rank MIMO communication with the apparatus 1008 on the two or more frequency bands in approximately the same direction.

The number and arrangement of components shown in FIG. 10 are provided as an example. In practice, there may be additional components, fewer components, different components, or differently arranged components than those shown in FIG. 10. Furthermore, two or more components shown in FIG. 10 may be implemented within a single component, or a single component shown in FIG. 10 may be implemented as multiple, distributed components. Additionally, or alternatively, a set of (one or more) components shown in FIG. 10 may perform one or more functions described as being performed by another set of components shown in FIG. 10.

The following provides an overview of some Aspects of the present disclosure:

Aspect 1: A method of wireless communication performed by a user equipment (UE), comprising: transmitting, via a transceiver of the UE to a network node, an indication of a capability to support high rank multiple input multiple output (MIMO) communication on two or more frequency bands that have a common intermediate frequency, wherein the capability to support the high rank MIMO communications includes a capability to support MIMO communication in approximately a same direction and on greater than two layers; and performing, via the transceiver, the high rank MIMO communication with the network node on the two or more frequency bands in approximately the same direction.

Aspect 2: The method of Aspect 1, wherein performing, via the transceiver, the high rank MIMO communication with the network node on the two or more frequency bands in approximately the same direction comprises: performing, via the transceiver, the high rank MIMO communication with the network node on a first frequency band, of the two or more frequency bands, using: a first subset of antenna elements on a first antenna module associated with the transceiver of the UE, and a first subset of antenna elements on a second antenna module associated with the transceiver of the UE; and performing, via the transceiver, the high rank MIMO communication with the network node on a second frequency band, of the two or more frequency bands, using: a second subset of antenna elements on a first antenna module associated with the transceiver of the UE, and a second subset of antenna elements on a second antenna module associated with the transceiver of the UE.

Aspect 3: The method of Aspect 2, wherein the first frequency band comprises an FR2 frequency band; and wherein the second frequency band comprises an FR3 frequency band or an FR4 frequency band.

Aspect 4: The method of Aspect 2 or 3, wherein the first antenna module is located on a first side of the UE; wherein the second antenna module is located on a second side of the UE; and wherein the first side and the second side are opposing sides of the UE.

Aspect 5: The method of any of Aspects 2-4, wherein the first antenna module is located on a first side of the UE; wherein the second antenna module is located on a second side of the UE; and wherein the first side and the second side are approximately orthogonal sides of the UE.

Aspect 6: The method of any of Aspects 2-5, wherein performing, via the transceiver, the high rank MIMO communication with the network node on the first frequency band comprises: performing, via the transceiver, the high rank MIMO communication with the network node on the first frequency band via two or more first spatial layers; and performing the high rank MIMO communication with the network node on the second frequency band via two or more second spatial layers.

Aspect 7: The method of any of Aspects 2-6, wherein transmitting, via the transceiver, the indication of the capability to support the high rank MIMO communication comprises: transmitting, via the transceiver, the indication of the capability to support the high rank MIMO communication based at least in part on a spatial separation between the first antenna module and the second antenna module satisfying a spatial separation threshold.

Aspect 8: The method of any of Aspects 1-7, wherein performing, via the transceiver, the high rank MIMO communication comprises: performing, via the transceiver, the high rank MIMO communication with the network node on a first frequency band, of the two or more frequency bands, using a first plurality of antenna elements on a first antenna module associated with the transceiver of the UE; and performing, via the transceiver, the high rank MIMO communication with the network node on a second frequency band, of the two or more frequency bands, using a second plurality of antenna elements on a second antenna module associated with the transceiver of the UE.

Aspect 9: The method of Aspect 8, wherein the first frequency band comprises an FR2 frequency band; and wherein the second frequency band comprises an FR3 frequency band or an FR4 frequency band.

Aspect 10: The method of Aspect 8 or 9, wherein the first antenna module is located on a first side of the UE; wherein the second antenna module is located on a second side of the UE; and wherein the first side and the second side are opposing sides of the UE.

Aspect 11: The method of any of Aspects 8-10, wherein the first antenna module is located on a first side of the UE; wherein the second antenna module is located on a second side of the UE; and wherein the first side and the second side are approximately orthogonal sides of the UE.

Aspect 12: The method of any of Aspects 8-11, wherein performing, via the transceiver, the high rank MIMO communication with the network node on the first frequency band comprises: performing, via the transceiver, the high rank MIMO communication with the network node on the first frequency band via two or more first spatial layers; and performing, via the transceiver, the high rank MIMO communication with the network node on the second frequency band via two or more second spatial layers.

Aspect 13: The method of any of Aspects 8-12, wherein transmitting, via the transceiver, the indication of the capability to support the high rank MIMO communication comprises: transmitting, via the transceiver, the indication of the capability to support the high rank MIMO communication based at least in part on a spatial separation between the first antenna module and the second antenna module satisfying a spatial separation threshold.

Aspect 14: The method of any of Aspects 1-13, wherein transmitting, via the transceiver, the indication of the capability to support the high rank MIMO communication comprises: transmitting, via the transceiver, an indication of a quantity of hybrid beamforming sets of beam weights to be supported for the high rank MIMO communication.

Aspect 15: The method of Aspect 14, wherein the quantity of hybrid beamforming sets of beam weights to be supported is greater than 2.

Aspect 16: The method of Aspect 14 or 15, wherein transmitting, via the transceiver, the indication of the capability to support the high rank MIMO communication comprises: transmitting, via the transceiver, an indication of a plurality of demodulation reference signal (DMRS) ports associated with a hybrid beamforming set of beam weights to be supported for the high rank MIMO communication.

Aspect 17: The method of any of Aspects 1-16, wherein transmitting, via the transceiver, the indication of the capability to support the high rank MIMO communication comprises: transmitting an indication of power and performance parameters for the high rank MIMO communication.

Aspect 18: A method of wireless communication performed by a network node, comprising: receiving, from a user equipment (UE), an indication of a capability of the UE to support high rank multiple input multiple output (MIMO) communication on two or more frequency bands that have a common intermediate frequency, wherein the capability to support the high rank MIMO communications includes a capability to support MIMO communication in approximately a same direction and on greater than two layers; and performing the high rank MIMO communication with the UE on the two or more frequency bands in approximately the same direction.

Aspect 19: The method of Aspect 18, wherein performing the high rank MIMO communication with the UE on the two or more frequency bands in approximately the same direction comprises: performing the high rank MIMO communication with the UE on a first frequency band, of the two or more frequency bands, via: a first subset of antenna elements on a first antenna module of the UE, and a first subset of antenna elements on a second antenna module of the UE; and performing the high rank MIMO communication with the UE on a second frequency band, of the two or more frequency bands, via: a second subset of antenna elements on a first antenna module of the UE, and a second subset of antenna elements on a second antenna module of the UE.

Aspect 20: The method of Aspect 19, wherein the first frequency band comprises an FR2 frequency band; and wherein the second frequency band comprises an FR3 frequency band or an FR4 frequency band.

Aspect 21: The method of Aspect 19 or 20, wherein performing the high rank MIMO communication with the UE on the first frequency band comprises: performing the high rank MIMO communication with the UE on the first frequency band via two or more first spatial layers; and performing the high rank MIMO communication with the UE on the second frequency band via two or more second spatial layers.

Aspect 22: The method of any of Aspects 19-21, wherein receiving the indication of the capability to support the high rank MIMO communication on the two or more frequency bands, that have the common intermediate frequency, in approximately the same direction comprises: receive the indication of the capability to support the high rank MIMO communication on the two or more frequency bands, that have the common intermediate frequency, in approximately the same direction based at least in part on a spatial separation between the first antenna module and the second antenna module satisfying a spatial separation threshold.

Aspect 23: The method of any of Aspects 18-22, wherein performing the high rank MIMO communication with the UE on the two or more frequency bands in approximately the same direction comprises: performing the high rank MIMO communication with the UE on a first frequency band, of the two or more frequency bands, via a plurality of antenna elements on a first antenna module of the UE; and performing the high rank MIMO communication with the UE on a second frequency band, of the two or more frequency bands, via a second plurality of antenna elements on a second antenna module of the UE.

Aspect 24: The method of Aspect 23, wherein the first frequency band comprises an FR2 frequency band; and wherein the second frequency band comprises an FR3 frequency band or an FR4 frequency band.

Aspect 25: The method of Aspect 23 or 24, wherein performing high rank MIMO communication with the UE on the first frequency band comprises: performing the high rank MIMO communication with the UE on the first frequency band via two or more first spatial layers; and performing the high rank MIMO communication with the UE on the second frequency band via two or more second spatial layers.

Aspect 26: The method of any of Aspects 23-25, wherein transmitting the indication of the capability to support the high rank MIMO communication comprises: receiving the indication of the capability to support the high rank MIMO communication based at least in part on a spatial separation between the first antenna module and the second antenna module satisfying a spatial separation threshold.

Aspect 27: The method of any of Aspects 19-26, wherein receiving the indication of the capability to support the high rank MIMO communication comprises: receiving an indication of a quantity of hybrid beamforming sets of beam weights to be supported for the high rank MIMO communication.

Aspect 28: The method of Aspect 27, wherein the quantity of hybrid beamforming sets of beam weights to be supported is greater than 2.

Aspect 29: The method of Aspect 27 or 28, wherein receiving the indication of the capability to support the high rank MIMO communication comprises: receiving an indication of a plurality of demodulation reference signal (DMRS) ports associated with a hybrid beamforming set of beam weights to be supported for the high rank MIMO communication.

Aspect 30: The method of any of Aspects 19-29, wherein receiving the indication of the capability to support the high rank MIMO communication comprises: receiving an indication of power and performance parameters for the high rank MIMO communication.

Aspect 31: An apparatus for wireless communication at a device, comprising a processor; memory coupled with the processor; and instructions stored in the memory and executable by the processor to cause the apparatus to perform the method of one or more of Aspects 1-30.

Aspect 32: A device for wireless communication, comprising a memory and one or more processors coupled to the memory, the one or more processors configured to perform the method of one or more of Aspects 1-30.

Aspect 33: An apparatus for wireless communication, comprising at least one means for performing the method of one or more of Aspects 1-30.

Aspect 34: A non-transitory computer-readable medium storing code for wireless communication, the code comprising instructions executable by a processor to perform the method of one or more of Aspects 1-30.

Aspect 35: A non-transitory computer-readable medium storing a set of instructions for wireless communication, the set of instructions comprising one or more instructions that, when executed by one or more processors of a device, cause the device to perform the method of one or more of Aspects 1-30.

The foregoing disclosure provides illustration and description but is not intended to be exhaustive or to limit the aspects to the precise forms disclosed. Modifications and variations may be made in light of the above disclosure or may be acquired from practice of the aspects.

As used herein, the term “component” is intended to be broadly construed as hardware and/or a combination of hardware and software. “Software” shall be construed broadly to mean instructions, instruction sets, code, code segments, program code, programs, subprograms, software modules, applications, software applications, software packages, routines, subroutines, objects, executables, threads of execution, procedures, and/or functions, among other examples, whether referred to as software, firmware, middleware, microcode, hardware description language, or otherwise. As used herein, a “processor” is implemented in hardware and/or a combination of hardware and software. It will be apparent that systems and/or methods described herein may be implemented in different forms of hardware and/or a combination of hardware and software. The actual specialized control hardware or software code used to implement these systems and/or methods is not limiting of the aspects. Thus, the operation and behavior of the systems and/or methods are described herein without reference to specific software code, since those skilled in the art will understand that software and hardware can be designed to implement the systems and/or methods based, at least in part, on the description herein.

As used herein, “satisfying a threshold” may, depending on the context, refer to a value being greater than the threshold, greater than or equal to the threshold, less than the threshold, less than or equal to the threshold, equal to the threshold, not equal to the threshold, or the like.

Even though particular combinations of features are recited in the claims and/or disclosed in the specification, these combinations are not intended to limit the disclosure of various aspects. Many of these features may be combined in ways not specifically recited in the claims and/or disclosed in the specification. The disclosure of various aspects includes each dependent claim in combination with every other claim in the claim set. As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (e.g., a+a, a+a+a, a+a+b, a+a+c, a+b+b, a+c+c, b+b, b+b+b, b+b+c, c+c, and c+c+c, or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or similar language is used. Also, as used herein, the terms “has,” “have,” “having,” or the like are intended to be open-ended terms that do not limit an element that they modify (e.g., an element “having” A may also have B). Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

What is claimed is:

1. A user equipment (UE) for wireless communication, comprising:
a memory;
a transceiver; and
one or more processors, coupled to the memory, configured to:
transmit, via the transceiver, to a network node, an indication of a capability to support high rank multiple input multiple output (MIMO) communication on two or more frequency bands that have a common intermediate frequency,
wherein the capability to support high rank MIMO communications includes a capability to support MIMO communication in approximately a same direction and on greater than two layers; and
perform, via the transceiver, the high rank MIMO communication with the network node on the two or more frequency bands in approximately the same direction.

2. The UE of claim 1, wherein the one or more processors, to perform, via the transceiver, the high rank MIMO communication with the network node on the two or more frequency bands in approximately the same direction, are configured to:
perform, via the transceiver, the high rank MIMO communication with the network node on a first frequency band, of the two or more frequency bands, using:
a first subset of antenna elements on a first antenna module associated with the transceiver of the UE, and
a first subset of antenna elements on a second antenna module associated with the transceiver of the UE; and
perform the high rank MIMO communication with the network node on a second frequency band, of the two or more frequency bands, using:
a second subset of antenna elements on the first antenna module associated with the transceiver of the UE, and
a second subset of antenna elements on the second antenna module associated with the transceiver of the UE.

3. The UE of claim 2, wherein the one or more processors, to perform, via the transceiver, the high rank MIMO communication with the network node on the first frequency band, are configured to:
perform, via the transceiver, the high rank MIMO communication with the network node on the first frequency band via two or more first spatial layers; and
perform, via the transceiver, the high rank MIMO communication with the network node on the second frequency band via two or more second spatial layers.

4. The UE of claim 2, wherein the one or more processors, to transmit the indication of the capability to support the high rank MIMO communication, are configured to:
transmit the indication of the capability to support the high rank MIMO communication based at least in part on a spatial separation between the first antenna module and the second antenna module satisfying a spatial separation threshold.

5. The UE of claim 1, wherein the one or more processors, to perform, via the transceiver, the high rank MIMO communication with the network node on the two or more frequency bands in approximately the same direction, are configured to:
perform the high rank MIMO communication with the network node on a first frequency band, of the two or more frequency bands, using a first plurality of antenna elements on a first antenna module associated with the transceiver of the UE; and
perform the high rank MIMO communication with the network node on a second frequency band, of the two or more frequency bands, using a second plurality of antenna elements on a second antenna module associated with the transceiver of the UE.

6. The UE of claim 5, wherein the one or more processors, to perform, via the transceiver, the high rank MIMO communication with the network node on the first frequency band, are configured to:
perform the high rank MIMO communication with the network node on the first frequency band via two or more first spatial layers; and
perform the high rank MIMO communication with the network node on the second frequency band via two or more second spatial layers.

7. The UE of claim 5, wherein the one or more processors, to transmit the indication of the capability to support the high rank MIMO communication, are configured to:
transmit the indication of the capability to support the high rank MIMO communication based at least in part on a spatial separation between the first antenna module and the second antenna module satisfying a spatial separation threshold.

8. The UE of claim 1, wherein the one or more processors, to transmit the indication of the capability to support the high rank MIMO communication, are configured to:
transmit an indication of a quantity of hybrid beamforming sets of beam weights to be supported for the high rank MIMO communication.

9. The UE of claim 8, wherein the quantity of hybrid beamforming sets of beam weights to be supported is greater than 2.

10. The UE of claim 8, wherein the one or more processors, to transmit the indication of the capability to support the high rank MIMO communication, are configured to:
transmit an indication of a plurality of demodulation reference signal (DMRS) ports associated with a hybrid beamforming set of beam weights to be supported for the high rank MIMO communication.

11. The UE of claim 1, wherein the one or more processors, to transmit the indication of the capability to support the high rank MIMO communication, are configured to:
transmit an indication of power and performance parameters for the high rank MIMO communication.

12. A network node for wireless communication, comprising:
a memory; and
one or more processors, coupled to the memory, configured to:
receive, from a user equipment (UE), an indication of a capability of the UE to support high rank multiple input multiple output (MIMO) communication on two or more frequency bands that have a common intermediate frequency,
wherein the capability to support the high rank MIMO communication includes a capability to support MIMO communication in approximately a same direction and on greater than two layers; and
perform the high rank MIMO communication with the UE on the two or more frequency bands in approximately the same direction.

13. The network node of claim 12, wherein the one or more processors, to perform high rank MIMO communication with the UE on the two or more frequency bands in approximately the same direction, are configured to:
perform the high rank MIMO communication with the UE on a first frequency band, of the two or more frequency bands, via:
a first subset of antenna elements on a first antenna module of the UE, and
a first subset of antenna elements on a second antenna module of the UE; and
perform the high rank MIMO communication with the UE on a second frequency band, of the two or more frequency bands, via:
a second subset of antenna elements on a first antenna module of the UE, and
a second subset of antenna elements on a second antenna module of the UE.

14. The network node of claim 13, wherein the first frequency band comprises an FR2 frequency band; and
wherein the second frequency band comprises an FR3 frequency band or an FR4 frequency band.

15. The network node of claim 13, wherein the one or more processors, to perform the high rank MIMO communication with the UE on the first frequency band, are configured to:
perform the high rank MIMO communication with the UE on the first frequency band via two or more first spatial layers; and
perform the high rank MIMO communication with the UE on the second frequency band via two or more second spatial layers.

16. The network node of claim 12, wherein the one or more processors, to receive the indication of the capability to support the high rank MIMO communication, are configured to:
receive the indication of the capability to support the high rank MIMO communication based at least in part on a spatial separation between the first antenna module and the second antenna module satisfying a spatial separation threshold.

17. The network node of claim 12, wherein the one or more processors, to perform the high rank MIMO communication with the UE on the two or more frequency bands in approximately the same direction, are configured to:
perform the high rank MIMO communication with the UE on a first frequency band, of the two or more frequency bands, via a plurality of antenna elements on a first antenna module of the UE; and
perform the high rank MIMO communication with the UE on a second frequency band, of the two or more frequency bands, via a second plurality of antenna elements on a second antenna module of the UE.

18. The network node of claim 17, wherein the first frequency band comprises an FR2 frequency band; and
wherein the second frequency band comprises an FR3 frequency band or an FR4 frequency band.

19. The network node of claim 17, wherein the one or more processors, to perform the high rank MIMO communication with the UE on the first frequency band, are configured to:
perform the high rank MIMO communication with the UE on the first frequency band via two or more first spatial layers; and
perform the high rank MIMO communication with the UE on the second frequency band via two or more second spatial layers.

20. The network node of claim 12, wherein the one or more processors, to transmit the indication of the capability to support the high rank MIMO communication, are configured to:
receive the indication of the capability to support the high rank MIMO communication based at least in part on a spatial separation between the first antenna module and the second antenna module satisfying a spatial separation threshold.

21. The network node of claim 12, wherein the one or more processors, to receive the indication of the capability to support the high rank MIMO communication, are configured to:
receive an indication of a quantity of hybrid beamforming sets of beam weights to be supported for the high rank MIMO communication.

22. The network node of claim 21, wherein the quantity of hybrid beamforming sets of beam weights to be supported is greater than 2.

23. The network node of claim 12, wherein the one or more processors, to receive the indication of the capability to support high rank MIMO communication, are configured to:
receive an indication of a plurality of demodulation reference signal (DMRS) ports associated with a hybrid beamforming set of beam weights to be supported for high rank MIMO communication.

24. The network node of claim 12, wherein the one or more processors, to receive the indication of the capability to support high rank MIMO communication, are configured to:
receive an indication of power and performance parameters for high rank MIMO communication.

25. A method of wireless communication performed by a user equipment (UE), comprising:
transmitting, via a transceiver of the UE and to a network node, an indication of a capability to support high rank multiple input multiple output (MIMO) communication on two or more frequency bands that have a common intermediate frequency,
wherein the capability to support the high rank MIMO communication includes a capability to support MIMO communication in approximately a same direction and on greater than two layers; and
performing, via the transceiver, the high rank MIMO communication with the network node on the two or more frequency bands in approximately the same direction.

26. The method of claim 25, wherein performing, via the transceiver, the high rank MIMO communication with the network node on the two or more frequency bands in approximately the same direction comprises:
performing, via the transceiver, the high rank MIMO communication with the network node on a first frequency band, of the two or more frequency bands, using:
a first subset of antenna elements on a first antenna module associated with the transceiver of the UE, and
a first subset of antenna elements on a second antenna module associated with the transceiver of the UE; and
performing, via the transceiver, the high rank MIMO communication with the network node on a second frequency band, of the two or more frequency bands, using:
a second subset of antenna elements on the first antenna module associated with the transceiver of the UE, and
a second subset of antenna elements on the second antenna module associated with the transceiver of the UE.

27. The method of claim 26, wherein performing, via the transceiver, the high rank MIMO communication with the network node on the first frequency band comprises:
performing, via the transceiver, the high rank MIMO communication with the network node on the first frequency band via two or more first spatial layers; and
performing, via the transceiver, the high rank MIMO communication with the network node on the second frequency band via two or more second spatial layers.

28. The method of claim 26, wherein transmitting the indication of the capability to support high rank MIMO communication comprises:
transmitting the indication of the capability to support high rank MIMO communication based at least in part on a spatial separation between the first antenna module and the second antenna module satisfying a spatial separation threshold.

29. The method of claim 25, wherein performing, via the transceiver, the high rank MIMO communication with the network node on the two or more frequency bands in approximately the same direction comprises:
performing the high rank MIMO communication with the network node on a first frequency band, of the two or more frequency bands, using a first plurality of antenna elements on a first antenna module associated with the transceiver of the UE; and
performing the high rank MIMO communication with the network node on a second frequency band, of the two or more frequency bands, using a second plurality of antenna elements on a second antenna module associated with the transceiver of the UE.

30. The method of claim 29, wherein transmitting the indication of the capability to support the high rank MIMO communication comprises:
transmitting the indication of the capability to support the high rank MIMO communication based at least in part on a spatial separation between the first antenna module and the second antenna module satisfying a spatial separation threshold.

31. The method of claim 25, wherein transmitting the indication of the capability to support the high rank MIMO communication comprises:
transmitting an indication of a quantity of hybrid beamforming sets of beam weights to be supported for the high rank MIMO communication.

32. The method of claim 31, wherein the quantity of hybrid beamforming sets of beam weights to be supported is greater than 2.

33. The method of claim 31, wherein transmitting the indication of the capability to support the high rank MIMO communication comprises:
transmitting an indication of a plurality of demodulation reference signal (DMRS) ports associated with a hybrid beamforming set of beam weights to be supported for the high rank MIMO communication.

34. The method of claim 25, wherein transmitting the indication of the capability to support the high rank MIMO communication comprises:
transmitting an indication of power and performance parameters for the high rank MIMO communication.

35. A method of wireless communication performed by a network node, comprising:
receiving, from a user equipment (UE), an indication of a capability of the UE to support high rank multiple input multiple output (MIMO) communication on two or more frequency bands that have a common intermediate frequency,
wherein the capability to support the high rank MIMO communication includes a capability to support MIMO communication in approximately a same direction and on greater than two layers; and
performing the high rank MIMO communication with the UE on the two or more frequency bands in approximately the same direction.

36. The method of claim 35, wherein performing the high rank MIMO communication with the UE on the two or more frequency bands in approximately the same direction comprises:
performing the high rank MIMO communication with the UE on a first frequency band, of the two or more frequency bands, via:
a first subset of antenna elements on a first antenna module of the UE, and
a first subset of antenna elements on a second antenna module of the UE; and
performing the high rank MIMO communication with the UE on a second frequency band, of the two or more frequency bands, via:
a second subset of antenna elements on a first antenna module of the UE, and
a second subset of antenna elements on a second antenna module of the UE.

37. The method of claim 36, wherein the first frequency band comprises an FR2 frequency band; and
wherein the second frequency band comprises an FR3 frequency band or an FR4 frequency band.

38. The method of claim 36, wherein performing the high rank MIMO communication with the UE on the first frequency band comprises:
performing the high rank MIMO communication with the UE on the first frequency band via two or more first spatial layers; and
performing the high rank MIMO communication with the UE on the second frequency band via two or more second spatial layers.

39. The method of claim 36, wherein receiving the indication of the capability to support the high rank MIMO communication comprises:
receive the indication of the capability to support the high rank MIMO communication based at least in part on a spatial separation between the first antenna module and the second antenna module satisfying a spatial separation threshold.

40. The method of claim 35, wherein performing the high rank MIMO communication comprises:
performing the high rank MIMO communication with the UE on a first frequency band, of the two or more frequency bands, via a plurality of antenna elements on a first antenna module of the UE; and
performing the high rank MIMO communication with the UE on a second frequency band, of the two or more frequency bands, via a second plurality of antenna elements on a second antenna module of the UE.

41. The method of claim 40, wherein the first frequency band comprises an FR2 frequency band; and
wherein the second frequency band comprises an FR3 frequency band or an FR4 frequency band.

42. The method of claim 40, wherein performing the high rank MIMO communication comprises:
performing the high rank MIMO communication with the UE on the first frequency band via two or more first spatial layers; and
performing the high rank MIMO communication with the UE on the second frequency band via two or more second spatial layers.

43. The method of claim 40, wherein receiving the indication of the capability to support the high rank MIMO communication comprises:
receiving the indication of the capability to support the high rank MIMO communication based at least in part on a spatial separation between the first antenna module and the second antenna module satisfying a spatial separation threshold.

44. The method of claim 35, wherein receiving the indication of the capability to support the high rank MIMO communication comprises:
receiving an indication of a quantity of hybrid beamforming sets of beam weights to be supported for the high rank MIMO communication.

45. The method of claim 44, wherein the quantity of hybrid beamforming sets of beam weights to be supported is greater than 2.
